(19) United States
(12) Patent Application Publication
(10) Pub. No.: US 2008/0198787 A1
(43) Pub. Date: Aug. 21, 2008

(54) Mobile Data Object Transmission Over Wireless Communication Networks Using UDP and Two Level Protocol

(75) Inventor: Van NGUYEN, Alpharetta, GA (US)

Correspondence Address: MORRIS MANNING MARTIN LLP, 3343 PEACHTREE ROAD, NE, 1600 ATLANTA FINANCIAL CENTER, ATLANTA, GA, 30326, US

(73) Assignee: AGENTEK, INC., Alpharetta, GA (US)

(21) Appl. No.: 11/931,799

(22) Filed: Oct. 31, 2007

Related U.S. Application Data
(60) Provisional application No. 60/890,109, filed on Feb. 15, 2007.

(51) Int. Cl. H04B 7/14

(52) U.S. Cl. 370/315

(57) ABSTRACT

Systems and methods for data communication between multiple computing devices, comprising: transmitting data through a selectable communication medium by constructing a frame for data, dividing the frame into TXU packets, dividing each TXU packet into UDP segments; grouping the UDP segments into windows; and sending each window to a second computing device; receiving the data at the second computing device comprising receiving UDP segments, assembling UDP segments to recreate TXU packets, sending an ACK message for the first UDP segment of each non-final window and for the last UDP segment of a TXU packet of a final window to the first computing device, and sending a NAK message, specifying missing segments; the first computing device, upon receiving the ACK message, sending the next window, and upon receiving a NAK message, retransmitting missing UDP segments; and at the second computing device, upon receiving a final TXU packet for a frame, recreating the frame by reassembling the TXU packets. Probe messages are sent for missing ACKs and NAKs.

### CROSS-REFERENCE TO RELATED APPLICATIONS

This application claims the benefit under 35 U.S.C. § 119(e) of U.S. Provisional Patent Application Ser. No. 60/890,109, entitled “Mobile Data Object Transmission Over Wireless Communication Networks Using UDP and Two Level Protocol,” filed Feb. 15, 2007, which is incorporated herein by reference as if set forth herein in its entirety.

### TECHNICAL FIELD

The present invention generally relates to a data communication system. More particularly, the present invention relates to a mobile data object communication system with at least a portion of the communication typically conducted over wireless communication networks.

### BACKGROUND

Wireless networks such as GPRS (General Packet Radio Service), CDMA (Code Division Multiple Access), GSM (Global System for Mobile communications), and other similar wireless networks are becoming more widely deployed and are increasingly more often used to access services on the Internet. Traditionally, Transmission Control Protocol (TCP) is widely used in communications over wireless networks. TCP technology has been very successful providing services to users of fixed, wired networks. For wireless networks, TCP performance is reportedly much lower than for fixed networks. TCP was designed for networks with wired links and stationary hosts. In these wired networks, data is lost primarily due to congestion. TCP typically interprets data loss as congestion in the network, and for data loss TCP slows the transmission rate in an attempt to reduce the congestion. In a wireless network, one can not assume that data losses are caused by congestion. Instead, data loss is more often caused by the relative low quality of the wireless link. Terminal mobility, which is supported by many wireless networks, may also result in data loss. If data is lost for some reason other than congestion, then performance is unnecessarily degraded as TCP reduces its transmission rate in response to the loss. Therefore, one reason for performance degradation is that TCP works less efficiently in wireless networks.

A wireless network comprises a plurality of mobile stations and a plurality of intermediate nodes. The intermediate nodes are required to connect the wireless communication network to wired communication networks. For example, an inter-working unit is used to connect a cellular telephony network to a wired network.

Wireless links are not as robust as wired links, since the radio quality may vary considerably over time, the bandwidth is usually lower, and transmission errors occur more frequently. Sending signals over an omni-directional radio based medium gives rise to more errors than in a guided medium such as fiber or coax. Signal strength weakens with the distance between a mobile device and a mobile station. Additionally, radio waves bounce off objects, causing interference and multi-path effects.

Error correction, interleaving, and retransmissions are used at lower protocol layers to reduce transmission errors at the upper protocol layers. In many wireless networks, the data link layer performs error recovery according to some automatic repeat request (ARQ) protocol. ARQ is an error control method for data transmission which makes use of acknowledgments and timeouts to achieve reliable data transmission. An acknowledgment is a message sent by the receiver to the transmitter to indicate that it has correctly received a data frame. Usually, if the transmitter does not receive the acknowledgment before the timeout occurs (i.e. within a predetermined amount of time after sending the data frame), it retransmits the frame until it is either correctly received or the error persists beyond a predetermined number of retransmissions.

If the maximum number of retransmissions (or the maximum time spent retransmitting a frame) is limited to tens of retransmissions, then the ARQ protocol is defined as highly persistent or highly reliable. A low persistent or partially reliable ARQ protocol, on the other hand, retransmits a frame 2-5 times before it gives up and transmits the next frame instead.

In comparison to fixed networks, wireless networks may seem to have very similar properties. However, when the radio quality is low, data loss may occur over a wireless link due to transmission errors. In cellular networks, handovers also cause data loss. Data loss due to handover occurs particularly often if a user moves at high speed from one wireless node to another. Handover typically results in delay and in many cases, data loss. Delay is introduced since it takes time to forward data to a new base station and to perform the handover procedure. Data loss occurs if an old base station flushes its buffer instead of forwarding data to the new base station. The handover is not transparent to TCP, since recovery of lost data introduces delay. Wireless networks have a long delay compared to wired networks, since transmission over a radio interface is slower than transmission over a wired medium. Additional delay may be introduced due to processing on a physical layer and on a data link layer. In cellular networks, processing on the physical layer (error correction and interleaving) is extensive and therefore produces a relatively long delay. On the data link layer, delay is increased by the use of MAC and ARQ. This delay is variable, since it depends on other users' activity (MAC) and on the radio conditions (ARQ). The delay variation experienced by TCP may become very large if the link layer ARQ is highly persistent as in GSM, GPRS and CDMA.

The performance of TCP is generally lower in wireless networks than in fixed networks. TCP is unable to distinguish problems that typically occur in wireless networks from the problems caused by network congestion. Although congestion control algorithms in TCP may be used to reduce the effects of the congestion, the congestion control algorithms are based on the assumptions that data is lost mainly due to congestion and that data loss due to transmission errors is rare. However, this assumption is no longer true for a wireless communication network. TCP segments may be lost if the radio conditions are poor and the link layer protocol provides a low reliability. After some retransmission attempts the link layer protocol gives up and leaves further error recovery to TCP. Handover events may also lead to data loss. A whole window of data may be lost due to handover. Data loss due to an unreliable link layer or a handover may cause a timeout event followed by slow start or three dupacks followed by fast retransmit and fast recovery. In either case, the congestion control action taken by TCP is unnecessary. Directly after the loss event, the radio quality may become high again, and after handover data may be transmitted without problems to the new mobile station.

TCP may also misinterpret a sudden increase in the round trip time as data loss. If the delay is long enough for the retransmission timer to expire before an acknowledgment is received, then TCP misinterprets the delay as an indication of data loss due to congestion. The delayed data is unnecessarily retransmitted and TCP enters slow start. A highly variable round trip time can also lead to a large retransmission timeout value (RTO), since the RTO is based both on estimates of the round trip time and on variations in the round trip time. If the RTO is large, then TCP reacts slowly to data loss. Variations in the round trip time can be caused by link level retransmissions of a wireless link. If the link layer frames that contain a TCP segment must be retransmitted because of a poor radio environment, then the whole segment is delayed. Round trip time variations may also be caused by handover or competing traffic. Queuing in routers, base stations, and other intermediate nodes may also lead to a long round trip time. A long round trip time may cause low throughput and underutilization of the network, since it takes a number of round trip times before the congestion window reaches the capacity of the network. TCP performance is degraded, especially for short lived flows, which transmits a small amount of data.

Therefore, it is apparent that a heretofore unaddressed need exists in the art to address the aforementioned deficiencies and inadequacies.

### SUMMARY

The present invention provides systems and methods for mobile data object communications between multiple computing devices over a selectable communication medium.

One embodiment provides a method for data communication between a remote electronic device and a server, comprising transmitting data through a selectable communication medium to the server, constructing a frame for data, the frame comprising a frame header and a frame body, the frame header including an agent type, an agent name, and a data length, and the frame body including a data buffer corresponding to the data length; dividing the frame into TXU packets that collectively comprise the frame body, wherein a TXU packet comprises a packet header and a packet body, the packet header including a packet type, a session ID, a pipe number, and a packet length, and the packet body including packet data corresponding to the packet length; dividing the TXU packet into UDP segments comprising a UDP header and a UDP body, the UDP header including a UDP type, a packet ID, a segment number, a last segment, and the UDP body including a data payload of predetermined size; grouping the UDP segments into at least one window, for transmission through the selectable communication medium, wherein the window includes a predetermined number of UDP segments; and sending the window to the server; and at the server, receiving the data through the selectable communication medium from the remote electronic device, comprising: receiving at least one UDP segment; assembling UDP segments to recreate the TXU packet; upon determination that the segment number of the UDP segment indicates a window segment prior to a final window segment for the TXU packet, sending an ACK to the remote electronic device; upon determination that at least one UDP segment was not received, sending a NAK message to the remote electronic device, specifying the segment number for each missing segment; and upon determination that a final UDP segment for the TXU packet has been received, sending an ACK message to the remote electronic device; at the remote electronic device, upon receiving the ACK message from the server, if a next window remains to be sent, sending the next window from the remote electronic device to the server; at the remote electronic device, upon receipt of the NAK message: retransmitting missing UDP segments to the server, comprising: identifying missing UDP segments according to the NAK message; grouping the missing UDP segments into a retransmit window having a number of UDP segments corresponding to a count of missing UDP segments; and sending the retransmit window to the server; and at the server, upon determination that a final TXU packet for the frame has been received, recreating the frame by reassembling the plurality of TXU packets.

Another embodiment provides a method for data communication between a first computing device and a second computing device, comprising: at the first computing device, transmitting data through a selectable communication medium to the second computing device comprising: constructing a frame for the data; dividing the frame into TXU packets; dividing each TXU packet into UDP segments; grouping the UDP segments into at least one window, wherein the window includes a predetermined number of UDP segments from the UDP segments; and sending the window to the second computing device; at the second computing device, receiving the data through the selectable communication medium from the first computing device, comprising: receiving a UDP segment; assembling the UDP segments to recreate a TXU packet; upon determination that a last UDP segment for the TXU packet that has been received, sending an ACK message to the first computing device; and upon determination that at least one UDP segment was not received, sending a NAK message, that specifies each missing segment, to the first computing device; at the first computing device, upon receiving the ACK message, if a next window remains to be sent, sending the next window from the first computing device to the second computing device; at the first computing device, upon receiving a NAK message, retransmitting at least one missing UDP segment to the second computing device; and at the second computing device, upon determination that a final TXU packet for the frame has been received, recreating the frame by reassembling the TXU packets.

Another embodiment provide a method for data communication between a remote electronic device and a server, comprising: transmitting data from the remote electronic device through a selectable communication medium to the server, comprising: constructing a frame for data comprising a frame header and a frame body, the frame header including an agent type, an agent name, and a data length, and the frame body including a data buffer corresponding to the data length; dividing the frame into TXU packets that collectively comprise the frame body, wherein a TXU packet comprises a packet header and a packet body, the packet header including a packet type, a session ID, a pipe number, and a packet length, and the packet body including packet data corresponding to the packet length; dividing the TXU packet into UDP segments, wherein a UDP segment comprises a UDP header and a UDP body, the UDP header including a UDP type, a packet ID, a segment number, a last segment, and the UDP body including a data payload of predetermined size; grouping the UDP segments into at least one window, for transmission through the selectable communication medium, wherein the window includes a predetermined number of UDP segments; and sending the window to the server; upon receiving an ACK message from the server, if a next window remains to be sent, sending the next window from the remote electronic device to the server; upon receipt of a NAK message: retransmitting missing UDP segments from the remote electronic device to the server, comprising: identifying missing UDP segments according to the NAK message; grouping the missing UDP segments into a retransmit window, the retransmit window having a number of UDP segments corresponding to a count of missing UDP segments; and sending the retransmit window to the server.

Another embodiment provides a method for receiving data from a remote electronic device through a selectable communication medium, comprising: receiving a plurality of UDP segments, wherein a UDP segment comprises a UDP header and a UDP body, the UDP header including a UDP type, a packet ID, a segment number, a last segment, and the UDP body including a data payload of predetermined size; upon determination that the segment number indicates a first UDP segment, creating a TXU packet, the TXU packet comprising a packet header, and a packet body, the packet header including a packet type, a session ID, a pipe number, and a packet length, and the packet body including packet data corresponding to the packet length; upon determination that the segment number indicates the UDP segment sequentially after the first UDP segment, adding the UDP segment to the TXU packet; upon determination that the segment number indicates an initial segment in a window prior to a final window initial segment for the TXU packet, sending an ACK to the remote electronic device; upon determination that the UDP segment was not received, sending a NAK message to the remote electronic device, the NAK message specifying the segment number for each missing segment; upon determination that the segment number indicates the last segment, verifying that all UDP segments have been received; upon determination that all UDP segments have been received, sending an ACK message to the remote electronic device; upon determination that a final TXU packet has been received, recreating a frame by reassembling a plurality of TXU packets, the frame comprising a frame header and a frame body, the frame header including an agent type, an agent name, and a data length, and the frame body including a data buffer for data and corresponding to the data length.

Another embodiment provides a system for data communication between multiple computing devices, comprising: a first computing device configured for communication through a selectable communication medium with a second computing device, the first computing device comprising: a first TXM module operable for: receiving the data from a first application; constructing a frame for the data; dividing the frame into TXU packets that collectively comprise a frame body; sending a TXU packet to a first TXU module; and upon receiving notification that the TXU packet has been sent successfully, if a next TXU packet remains to be sent, sending the next TXU packet to the first TXU module; the first TXU module operable for: receiving the TXU packet from the first TXM module; dividing the TXU packet into UDP segments; grouping the UDP segments into at least one window, wherein the window includes a predetermined number of UDP segments; and sending the window through the selectable communication medium to a second TXU module at the second computing device; upon receipt of an ACK message, if a next window remains, sending the next window to the second TXU module; and upon the receipt of a NAK message, that specifies at least one missing UDP segment, retransmitting the missing UDP segment to the second TXU module; the second computing device configured for communication through the selectable communication medium with the first computing device, the second computing device comprising: the second TXU module operable for: receiving a UDP segment of the window, through the selectable communication medium from the first TXU module; assembling the UDP segment to recreate the TXU packet; upon determination that at least one UDP segment was not received, sending the NAK message through the selectable communication medium to the first TXU module, specifying the missing UDP segment; and upon determination that a final UDP segment for the TXU packet has been received: sending the ACK message to the first TXU module; sending the TXU packet to a second TXM module; the second TXM module operable for: receiving the TXU packet from the second TXU module; upon determination that the TXU packet is a first TXU packet for a new frame, creating the new frame; upon determination that a final TXU packet for the new frame has been received, recreating the new frame by reassembling the TXU packets that include the data; and providing the data from the new frame to a second application.

Another embodiment provides a method for transporting agents having related tasks, that enables agents to perform tasks at separate computing devices, comprising: at a first computing device, having an agent with a first executable code for a first task and a second executable code for a second task: determining whether first resources are available at the first computing device; upon verifying that first resources are available at the first computing device, performing the first task; upon determination that the second task is required, determining whether second resources are available at the first computing device; upon determination that the second resources are not available at the first computing device, determining whether the second resources are available at a second computing device; and upon determination that the second resources are available at the second computing device, transporting the agent through a selectable communication medium to the second computing device; and at the second computing device: receiving the agent from the first computing device; and performing the second task.

Another embodiment provides a method for transporting agents having related tasks, that enables agents to perform tasks at separate computing devices, comprising: at a first computing device, having an agent with a first executable code for a first task and a second executable code for a second task, upon determination that the first task is required: determining whether first resources are available at the first computing device; upon verifying that first resources are available at the first computing device, performing the first task; upon determination that the second task is required, determining whether second resources are available at the first computing device; upon determination that the second resources are not available at the first computing device, determining whether the second resources are available at a second computing device; upon determination that the second resources are available at the second computing device, transporting the agent to the second computing device, comprising: transmitting the agent through a selectable communication medium to the second computing device comprising: constructing a frame for agent data, wherein the agent data includes the first executable code for the first task, and the second executable code for the second task; dividing the frame into TXU packets that collectively comprise a frame body; dividing a TXU packet into UDP segments; grouping the UDP segments into at least one window, for transmission through the selectable communication medium, wherein the window includes a predetermined number of UDP segments; and sending the window to the second computing device; at the second computing device, receiving the agent data through the selectable communication medium from the first computing device, comprising: receiving UDP segments; assembling the UDP segments to recreate the TXU packet; upon determination that a UDP segment corresponds to a window first segment prior to a final window first segment for the TXU packet, sending an ACK to the first computing device; upon determination that at least one UDP segment was not received, sending a NAK message to the first computing device, specifying a segment number for each missing UDP segment; and upon determination that a final UDP segment for the TXU packet has been received, sending an ACK message to the first computing device; at the first computing device, upon receiving the NAK message, retransmitting at least one missing UDP segment to the second computing device; and at the second computing device, upon determination that a final TXU packet for the frame has been assembled, recreating the frame for the agent data by reassembling the TXU packets; and performing the second task.

Another embodiment provides a method for transporting and executing agents having related tasks, that enables the agents to execute portions of related tasks at different computing devices, comprising: at a first computing device: receiving an agent into a first module space corresponding to the agent, wherein the first module space comprises space information for transport and execution of the agent; upon determination that a first task is required, determining whether first resources are available; upon verifying availability of first resources, performing the first task; upon determination that a second task is required, determining whether second task resources are available at the first computing device; upon determination that the second task resources are unavailable at the first computing device, transporting the agent to a second computing device, comprising: at the first computing device, transmitting the agent through a selectable communication medium to the second computing device comprising: constructing a frame for agent data; dividing the frame into TXU packets that collectively comprise a frame body; dividing each TXU packet into UDP segments; grouping the UDP segments into at least one window for transmitting through the selectable communication medium, wherein the window includes a predetermined number of UDP segments; and sending the window to the second computing device; at the second computing device, receiving the agent data through the selectable communication medium from the first computing device, comprising: receiving at least one UDP segment; assembling UDP segments to recreate a TXU packet; upon determination that at least one UDP segment was not received, sending a NAK message to the first computing device, specifying the missing UDP segment; and upon determination that a final UDP segment for the TXU packet has been received, sending an ACK message to the first computing device; at the first computing device, upon receiving the NAK message, retransmitting the UDP segment to the second computing device; and at the second computing device, upon determination that a final TXU packet for the frame has been assembled, recreating the frame for the agent data by reassembling the TXU packets; and performing the second task.

Another embodiment provides a method for transporting and executing agents having related tasks, that enables agents to perform tasks at separate computing devices, comprising: at a first computing device, receiving an agent into a first module space corresponding to the agent, wherein the first module space comprises space information for transport and execution of the agent; upon determination that a task is required, determining whether task resources are available at the first computing device; upon determination that the task resources are unavailable at the first computing device, transporting the agent to a second computing device, comprising: allocating a session between the first module space on the first computing device and a second module space on the second computing device; opening a pipe through the session, the pipe having full duplex capability; and transmitting the agent through the pipe to the second module space, wherein the agent is transmitted by the first module space through a selectable communication medium to the second module space; at the second computing device: receiving the agent into the second module space; and executing the task.

Another embodiment provides a method for transporting and executing agents having a plurality of related tasks, that enables agents to perform tasks at separate computing devices, comprising: at a first computing device: receiving an agent into a first module space corresponding to the agent, wherein the first module space comprises space information for transport and execution of the agent; upon determination that a task is required, determining whether task resources are available at the first computing device; upon determination that the task resources are unavailable, transporting the agent to a second computing device, comprising: allocating a session between the first module space and a second module space on the second computing device; opening a pipe through the session, the pipe having full duplex capability; and transmitting the agent through the pipe to the second module space, the transmitting comprising: at the first module space, transmitting the agent through a selectable communication medium to the second module space, comprising: constructing a frame for the agent; dividing the frame into TXU packets that collectively comprise a frame body; dividing each TXU packet into UDP segments; grouping the UDP segments into at least one window for transmitting through the selectable communication medium, wherein the window includes a predetermined number of UDP segments; and sending the window to the second module space; at the second computing device: receiving the agent into the second module space, comprising: receiving UDP segments; assembling the UDP segments to recreate a TXU packet; upon determination that at least one UDP segment was not received, sending a NAK message to the first module space, specifying a segment number for each missing UDP segment; and upon determination that a final UDP segment for the TXU packet has been received, sending an ACK message to the first computing device; at the first module space, upon receiving a NAK message, retransmitting missing UDP segments to the second module space; and at the second module space, upon determination that a final TXU packet for the frame has been assembled: recreating the frame for the agent by reassembling the TXU packets; and executing the task.

Other systems, methods, features and advantages of the present invention will be or become apparent to one with skill in the art upon examination of the following drawings and detailed description. It is intended that all such additional systems, methods, features and advantages be included within this description and be within the scope of the present disclosure.

### BRIEF DESCRIPTION OF THE DRAWINGS

Many aspects of the invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1 is a high level overview of exemplary aspects of a system for automatic mobile data object transmission over wireless communication networks using UDP and the TXP2 two level protocol.

FIG. 2 is a diagram illustrating the frame, packet, and UDP segment relationships for the TXP2 two level protocol of FIG. 1.

FIG. 3 is a diagram illustrating TXP2 data transmission and re-transmission scenarios for the TXP2 frame of FIG. 2.

FIG. 4 is a high level flowchart of the TXP2 algorithm for FIG. 1.

FIG. 5A is a detailed flowchart of the TXP2 algorithm for sending data according to FIG. 1.

FIG. 5B is a detailed flowchart of the TXP2 algorithm for receiving data according to FIG. 1.

FIG. 6 is an illustration of exemplary aspects of the TXP2 communications protocol functionality of FIG. 1

FIG. 7 is a diagram illustrating the differences between the OSI model and the TXP2 model.

FIG. 8 is a diagram illustrating the probe functionality of the TXP2 protocol.

FIG. 9 is a diagram illustrating multiple mobile devices and other devices using the TXP2 protocol of FIG. 1.

### DETAILED DESCRIPTION

Prior to a detailed description of the invention(s), the following definitions are provided as an aid to understanding the subject matter and terminology of aspects of the present invention(s), are exemplary, and not necessarily limiting of the invention(s), which are expressed in the claims. Whether or not a term is capitalized is not considered definitive or limiting of the meaning of a term. As used in this document, a capitalized term shall have the same meaning as an uncapitalized term, unless the context of the usage specifically indicates that a more restrictive meaning for the capitalized term is intended. A capitalized term within the glossary usually indicates that the capitalized term has a separate definition within the glossary. However, the capitalization or lack thereof within the remainder of this document is not intended to be necessarily limiting unless the context clearly indicates that such limitation is intended.

### DEFINITIONS/GLOSSARY

Agents: Data communication objects that contain both executable code and data necessary for performing specific tasks on a computer or computerized device. Agents may be sent from one computer or device to another and, once transmitted, require no interaction with the transmitting device to complete their task.

Application: A computer program that operates on a computer system, e.g., but not limited to, a computer program operated on a TXP2 server, or a computer program operated within a mobile device (a mobile application). Further examples of applications include programs that perform a search in a database, receive and store information in a temporary memory of a mobile device, display selected information on a mobile device, display results of processing, etc., and virtually any other type of program that generates transactions or is responsive to transactions.

Frame: A linear block of data that contains a frame header and a frame body. The frame header contains the information which identifies the frame type. The frame body contains the information about the agent which is its data and logic.

LAN: Local-area network, a collection of computers that are connected for electronic communications, typically located geographically close together (that is, in the same building).

Mobile device: Any device used for communication over a wireless communication networks, such as a handheld device, a cellular phone, a walkie-talkie, a personal digital assistant (PDA), a pager, a smart phone, or any combination thereof. Mobile devices operative in the present invention typically run a software program to effect the functionality described herein. Generally synonymous and used interchangeably with mobile phone, but a mobile device need not necessarily be a telephone-type instrument.

Multilayer Transportation: A process that combines certain aspects of the OSI Application, Session, and Transport layers for transmitting an agent from one computer or electronic device to another.

OCP: Object Communication Protocol.

Packets: A frame is subdivided into a plurality of TXU packets.

Protocol: A set of formal rules describing how to transmit data, especially across a network. Low level protocols define the electrical and physical standards to be observed, bit- and byte-ordering and the transmission and error detection and correction of the bit stream. High level protocols deal with the data formatting, including the syntax of messages, the terminal to computer dialogue, character sets, sequencing of messages, etc.

TXM: An application module that employs a frame transmission protocol of the same name to send and receive a variable sized block of data that contains the agent using the TXU module.

TXP2 database: A storage facility to store state information locally on each communicating electronic device's storage medium.

TXU: An application module that employs a packet transmission protocol of the same name that sends and receives fixed size data blocks that compose each frame.

Virtual Session: A communication process allowing multiple agents to be sent and received simultaneously to specified recipient applications regardless of the physical transmission layer and IP and port address changes of the communicating nodes.

Virtual Space: An information object maintained on each computer or electronic device, and containing information necessary for constructing an agent and the execution context of the agent.

UI: User Interface. Typically means a software application with which a user interacts for purposes of entering information, obtaining information, or causing functions of an associated system to execute; includes a mobile device user interface.

WANs: Wide-area networks, a collection of computers that are connection for electronic communications, typically where the computers are further apart than a LAN and are connected by telephone lines, fiber optic cables, satellite transmission, or radio waves.

WLAN: Wireless local area network, e.g., a technology that is used to connect devices, including mobile devices, laptops, desktop computers, entertainment equipment, etc., through a wireless radio signal. Examples include the known WiFi and WiMAX data communication standards.

Three modes of transporting an agent:

Real time Transport: A first electronic device sends and Agent to a second electronic device. Optionally, the second electronic device returns the Agent back to the first electronic device. In either case the first electronic device's application that sent the Agent waits for completion of the transport process before continuing execution.

Batch Transport: An application on a first electronic device sends an Agent to a second electronic device. The first electronic device's TXM module only tracks the state of the transmission of the Agent and not the execution. The application continues execution without waiting for status updates on the transport process.

Auto Transport: An application on a first electronic device sends an Agent to an application on a second electronic device. The TXM module will determine if real time mode is possible based off of network conditions and if so will report to the sending application that a real time transport has begun. Otherwise, the TXM module will report to the application that a batch transport has begun. This allows the application to wait only if real time mode is possible.

### System Overview

The embodiments of the present invention are preferably implemented as a special purpose or general-purpose computer including various computer hardware as discussed in greater detail below. Embodiments within the scope of the present invention also include computer-readable media for carrying or having computer-executable instructions or data structures stored thereon. Such computer-readable media can be any available media which can be accessed by a general purpose or special purpose computer, or downloadable to through wireless communication networks. By way of example, and not limitation, such computer-readable media can comprise physical storage media such as RAM, ROM, flash memory, EEPROM, CD-ROM, DVD, or other optical disk storage, magnetic disk storage or other magnetic storage devices, any type of removable non-volatile memories such as secure digital (SD), flash memory, memory stick etc., or any other medium which can be used to carry or store computer program code in the form of computer-executable instructions or data structures and which can be accessed by a general purpose or special purpose computer, or a mobile device.

When information is transferred or provided over a network or another communications connection (either hardwired, wireless, or a combination of hardwired or wireless) to a computer, the computer properly views the connection as a computer-readable medium. Thus, any such a connection is properly termed and considered a computer-readable medium. Combinations of the above should also be included within the scope of computer-readable media. Computer-executable instructions comprise, for example, instructions and data which cause a general purpose computer, special purpose computer, or special purpose processing device such as a mobile device processor to perform one specific function or a group of functions.

Those skilled in the art will understand the features and aspects of a suitable computing environment in which aspects of the invention may be implemented. Although not required, some of the inventions are described in the general context of computer-executable instructions, such as program modules, being executed by computers in networked environments. Such program modules are often reflected and illustrated by flow charts, sequence diagrams, exemplary screen displays, and other techniques used by those skilled in the art to communicate how to make and use such computer program modules. Generally, program modules include routines, programs, objects, components, data structures, etc. that perform particular tasks or implement particular abstract data types, within the computer. Computer-executable instructions, associated data structures, and program modules represent examples of the program code for executing steps of the methods disclosed herein. The particular sequence of such executable instructions or associated data structures represent examples of corresponding acts for implementing the functions described in such steps.

Those skilled in the art will also appreciate that the invention may be practiced in network computing environments with many types of computer system configurations, including personal computers, hand-held devices, multi-processor systems, microprocessor-based or programmable consumer electronics, networked PCs, minicomputers, mainframe computers, and the like. The invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

An exemplary system for implementing the inventions, which is not illustrated, includes a general purpose computing device in the form of a conventional computer, including a processing unit, a system memory, and a system bus that couples various system components including the system memory to the processing unit. The computer will typically include one or more magnetic hard disk drives (also called “data stores” or “data storage” or other names) for reading from and writing to. The drives and their associated computer-readable media provide nonvolatile storage of computer-executable instructions, data structures, program modules, and other data for the computer. Although the exemplary environment described herein employs a magnetic hard disk, a removable magnetic disk, removable optical disks, other types of computer readable media for storing data can be used, including magnetic cassettes, flash memory cards, digital video disks (DVDs), Bernoulli cartridges, RAMs, ROMs, and the like.

Computer program code that implements most of the functionality described herein typically comprises one or more program modules may be stored on the hard disk or other storage medium. This program code, as is known to those skilled in the art, usually includes an operating system, one or more application programs, other program modules, and program data. A user may enter commands and information into the computer through keyboard, pointing device, or other input devices (not shown), such as a microphone, game pad, satellite dish, scanner, or the like. These and other input devices are often connected to the processing unit through known electrical, optical, or wireless connections.

The main computer that affects many aspects of the inventions will typically operate in a networked environment using logical connections to one or more remote computers or data sources, which are described further below. Remote computers may be another personal computer, a server, a router, a network PC, a peer device or other common network node, and typically include many or all of the elements described above relative to the main computer system in which the inventions are embodied. The logical connections between computers include a local area network (LAN), a wide area network (WAN), and wireless LANs (WLAN) that are presented here by way of example and not limitation. Such networking environments are commonplace in office-wide or enterprise-wide computer networks, intranets and the Internet.

When used in a LAN or WLAN networking environment, the main computer system implementing aspects of the invention is connected to the local network through a network interface or adapter. When used in a WAN or WLAN networking environment, the computer may include a modem, a wireless link, or other means for establishing communications over the wide area network, such as the Internet. In a networked environment, program modules depicted relative to the computer, or portions thereof, may be stored in a remote memory storage device. It will be appreciated that the network connections described or shown are exemplary and other means of establishing communications over wide area networks or the Internet may be used.

Reference is now made in detail to the description of the embodiments of systems, apparatus, and methods for automatic mobile data object transmission over wireless communication networks using UDP and a two level protocol as illustrated in the drawings. The invention may, however, be embodied in many different forms and should not be construed as limited to the embodiments set forth herein; rather, these embodiments are intended to convey the scope of the invention to those skilled in the art. Furthermore, all “examples” given herein are intended to be non-limiting.

### TXP2 Overview

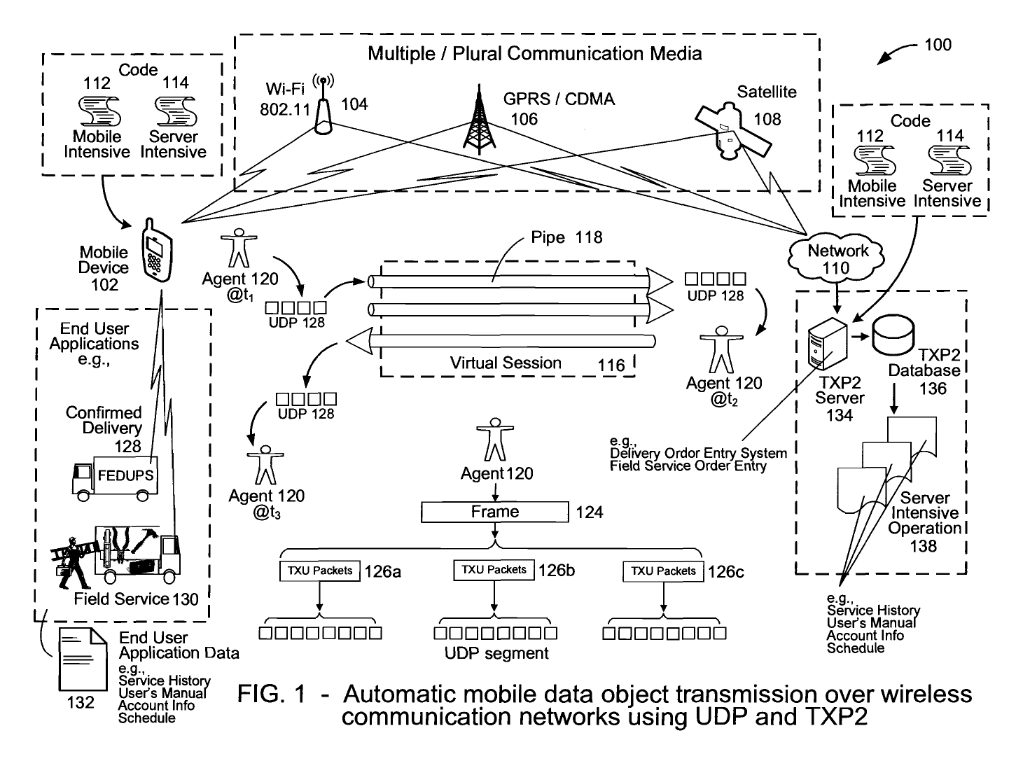

FIG. 1 is a high level overview of exemplary aspects of a system 100 for automatic mobile data object transmission over wireless communication networks using UDP and the TXP2 two level protocol. The systems and methods described provide for communications between two or more computing devices over a selectable communication medium. It should be noted that the system 100 typically uses a wireless network, though it also works well using traditional wired networks. Communications will typically involve a mobile device 102, such as a handheld computer for example, with a server 134 at a base of operations. Of course, multiple mobile devices 102 and/or multiple servers 134 or other computers can be utilized.

The discussion below will focus on four aspects of the present invention: (1) the TXP2 mobile object communication protocol, (2) mobile agents, (3) virtual spaces, and (4) virtual sessions.

The TXP2 mobile object communication protocol provides for communication between computing devices over a selectable communication medium. A particular strength of TXP2 is the ability to overcome the inherent limitations of wireless networks. However, TXP2 is a multilayer transportation protocol that combines certain aspects of the OSI model for transmitting data from one computer or electronic device to another, and can thus be applied to wireless as well as traditional wired communication networks. UDP is utilized in a dual protocol method rather than TCP for transmission of data, and achieves dramatically higher average data transmission rates over both wired and wireless networks than does TCP/IP.

Mobile agents are data communication objects containing both data and executable code necessary for performing specific tasks on a computer or other computerized device. The agents utilize the TXP2 protocol to travel from one computer to another. Further, the agents can perform tasks at the receiving computer or electronic device with complete independence from the sending device.

A virtual space information object provides the execution context for the mobile agent. TXP2 uses the virtual space on the sending computer to deconstruct the agent into a frame for sending through the selected communication medium. At the receiving computer, TXP2 uses the virtual space to reconstruct the agent and provide it to the application for execution.

A virtual session is a communication context between virtual spaces of communicating computers across a selected communication medium. The communication channel allows full duplex capability for mobile agents to travel between specified applications, independent of underlying IP and port address changes of the communicating nodes. Applications on computers or other electronic devices may send and receive agents over any IP based network simultaneously. One virtual session allows an application to communicate to any TXP2 enabled computers whereas TCP/IP communications require two sockets for each pair of communicating computers.

TXP2 is a mobile object communication protocol for overcoming the inherent limitations of networks, and particularly wireless networks. TXP2 uses the User Datagram Protocol (UDP) in a dual protocol method for its transmission of mobile object data. TXP2 allows applications on a computing device to communicate with applications on any number of other computing devices by sending and receiving agents over IP based networks simultaneously.

An agent is a communication data object that includes both data and executable code necessary for performing a task on a computer. Agent communications over wireless networks using TXP2 has several benefits. (1) Reduced network requests over the wireless network occur due to the composition of the transmitted data into discrete blocks of data objects as opposed to interactive streams. (2) The complex details of the wireless communication process are abstracted from the application logic. (3) Agents are typically compressed and encrypted before transmission providing efficient and secure communication. (4) A single virtual session is necessary for an application to communicate with other TXP2 enabled computing devices, while TCP/IP communication requires 2 sockets for each pair of communicating devices. (5) Wireless networks using TXP2 provide dramatically higher average data transmission rates compared with wireless networks using TCP/IP.

As noted previously, the benefits afforded to wireless communications by TXP2 also provide improvements for wired network communications. (1) Combining the data into discrete blocks of data objects rather than interactive streams reduces network requests for wired networks as well. Indeed, if the wired network functions with few transmission errors, then the requests necessary to correct those errors drop even more significantly. (2) The details for wired networks are typically not as complex as wireless networks, however, the abstraction remains and the communications process details are simplified at the application level. (3) Compression and encryption prior to transmission provides efficient and secure communications in both wired and wireless networks. (4) The virtual session operates the same in wired networks as in wireless networks and reduces the overhead significantly for TXP2 enabled devices. (5) Tests have shown that, similar to wireless networks, wired networks using TXP2 provide dramatically higher average data transmission rates compared with wired networks using TCP/IP.

TXP2 supports any type of IP based communication network, including wired networks, wireless networks, and satellite. For example, LAN, WAN, WLAN, Wi-Fi, GPRS (General Packet Radio Service), CDMA (Code Division Multiple Access), GSM (Global System for Mobile communications) and satellite communication protocols, among others, are supported. TXP2 eliminates many problems associated with sending data over wired networks, wireless networks, or combination networks, including among others, latency, packet loss, packet mangling, network node handoffs, and IP address changes associated with the sending and receiving nodes during transmission of data. TXP2 can typically be used for any IP based network, and the improved efficiency and performance when compared with TCP/IP based transport are especially significant when applied to both wired and wireless communications.

### TXP2 Communication

Turning again to FIG. 1, the system 100 allows customers such as, for example, but not limited to, a deliveryman 128 and a field service repairman 130, to utilize a mobile device 102 for communication with a TXP2 server 134 or other computing device over a network 110. The mobile device 102 typically accesses the network 110 using a variety of different wired or wireless channels such as, for example Wi-Fi 104, GPRS, CDMA, and/or GSM referred to collectively in this document as GPRS 106, and Satellite 108. Though FIG. 1 specifically illustrates the use of wireless networks, one of skill in the art will readily note that multiple types of devices may be configured using a variety of wired or wireless networks utilizing the systems and methods described herein.

The mobile device 102 and the server 134 each typically contain software that includes both mobile intensive code 112 and server intensive code 114. Mobile intensive code 112 is executable code having an emphasis on mobile device 102 functionality. Similarly, server intensive code 114 is executable code having an emphasis on server 134 functionality, such as performing server intensive operations 138, or accessing databases, for example.

A remote electronic device such as a mobile device 102 performs end user applications such as delivery confirmation 128, and field service 130, among others. End user applications often require end user application data 132 such as, for example, service history, user's manual, account information, and schedule information, among others. A mobile device 102 has capability for receiving, using, and changing end user application data 132.

A TXP2 server 134 provides services such as, for example, a delivery order entry system, or field service order entry, among others. The server 134 provides access to a TXP2 database 136 for such functionality as retrieving service history, user's manuals, account information, schedule information, and other server intensive operations 138. Of course, the server 134 also receives data from computer or other remote devices, such as the mobile device 102, and stores the data in the database 136.

In one exemplary embodiment, a deliveryman 128 communicates with a server 134 and confirms a delivery, for example. Of course, many delivery or field service type functions could be provided and confirmed using the systems and methods described.

In another exemplary embodiment, a field service repairman 130 requests information from a server 134. The requested information could include warranty status, account information, device model number, technical specification documents, user's manual, customer address, delivery schedule, or repair history, among others. One of skill in the art will readily recognize that multiple types of information related to customer equipment, location, or other factors could be provided through the network.

A pipe 118 is created for communications between a mobile device 102 and a server 134. The pipe 118 is allocated within a virtual session 116 (discussed in greater detail below) and is a full duplex communication channel between computers and/or other electronic devices. A pipe 118 typically connects two devices and provides communications using the TXP2 protocol to transmit UDP segments 128 over IP. An allocated pipe 118 is typically used for communication of a single data entity or object, and is terminated and released upon completion of the communication.

A data entity or object such as an agent 120 is transported from one device such as a mobile device 102, through a selected communication media to a server 134. The agent 120 is assembled into a frame 124, and the frame 123 is then deconstructed into TXU packets 126. TXU packets are divided into UDP segments 128 that are transferred through the pipe 118 (within a virtual session 116) to the server 134. The frame 124, TXU packets 126, and the UDP segments 128 are discussed in further detail below.

The agent 120 can be viewed as software including both data and executable code, and capable of performing a specific task on a computer or other electronic device. The agent 120 essentially travels from one computer to another, performs tasks or activities, and acts as a means of inter-process communication. In the present invention, agents 120 are sent using UDP and a two level protocol over wireless and wired networks 110. The agents 120 are constructed from any language that allows the status of agent transfer and agent execution to be reported to the sending computer. Additionally, communicating applications need only be concerned with the destination of the receiving application and the agents 120 being transferred, independent of the IP network and port address of the destination application. A communicating application uses a session identifier for keeping track of the communication information relating to the agent 120.

As shown in FIG. 1, an agent 120 at time t₁ is initially deconstructed into the UDP segments 128 that make up a frame. The UDP segments 128 are sent from the mobile device 102 through the pipe 118 to the TXP2 server 134. The UDP segments 128, and thus the agent 120, are received at the server 134 at a later time t₂. After performing its task, the agent 120 is returned to the mobile device 102 at a still later time t₃. The agent 120 can be viewed as having the capability to transport itself based on the transaction.

The mobile device 102 may use a variety of wireless technologies, including Wi-Fi, GPRS based telemetry, and satellite communication protocols to communicate with the TXP2 server 134. Further the communications can switch or be switched seamlessly from one channel of communication to another. It should be noted that since both the mobile intensive code 112 and the server intensive code 114 exist in both the mobile device 102 and the server 134, a lack of connection to the server typically does not hinder the end user application performance. For example, if customer 130 needs to get information regarding an appliance service tag from server 148, customer 130 tries to use the mobile device 104 to try to establish a connection with server 148. The TXP2 protocol tries to open a pipe 118 to send agent 122 from the mobile device 104 to the server 148. If mobile device 104 is unable to communicate with server 148, the agent 122 tries to run the server intensive code 102 in the mobile device itself and tries to return the needed data.

The TXP2 protocol has the capability for selecting between available communication media, and typically is used for selecting and/or switching among available wireless networks. It should be noted however, that the TXP2 protocol may also utilize more traditional wired networks and connections.

### TXP2 Example

To better illustrate the functionality and benefits of the TXP2 protocol, an illustration is provided. An agent 120 typically provides functionality for a handheld or mobile device 102. A field service technician 130 uses the mobile device 102 to acquire information related to a customer product from a server 134, to provide updated customer information as a result of a field service order, to acquire service history information, and to receive new scheduling assignments, for example.

From a home office location, the field service technician 130 typically acquires the scheduling information for that day's service calls via a Wi-Fi 104 communication medium such as an 802.11 wireless network within the office. TXP2 selects the Wi-Fi 104 communication medium as a first priority in this instance, since it is readily available and has low cost. As much of the customary information as necessary is easily downloaded into the mobile device 102 in a timely and cost effective manner.

The TXP2 protocol on the mobile device receives the agent 120 into a virtual space 604. The agent 120 is placed in a frame 124 format and deconstructed into TXU packets 126. The TXU packets 126 are then divided into UDP segments 128. Meanwhile, the TXP2 protocol at the mobile device 102 opens a virtual session 116 to the server 134, and allocates a pipe 118 through the virtual session 116 to the virtual space 604 at the server 134. The UDP segments 128 are then transmitted to the server 134 where the deconstruction process is reversed and the agent 120 is reconstructed and placed into the virtual space 604 at the server 134. The virtual space 604 at the server 134 is identical to the virtual space 604 at the mobile device 102

The agent 120 has thus transported itself to the server 134, where it acquires the day's schedule information from the database 136 by executing its server intensive code 114. The agent 120 also acquires the related product information for the scheduled service calls from the database 136, and then transfers itself back to the mobile device 102 through a pipe 118 allocated through the virtual session 116 by the TXP2 protocol. At the mobile device 102, the agent 120 executes mobile intensive code 112 to load the necessary schedule information. The agent 120 also checks for other information that may be needed for the service call, and discovers that one customer has a product that is no longer under warranty. The agent 120 then determines that an updated price structure for servicing that particular product needs to be acquired from the server 134. The agent 120 then transports itself back to the server 134 to acquire the updated product pricing structure. At the server 134, the agent 120 utilizes the server intensive code 114 to access the database 136 and acquire the updated product pricing structure. Finally, the agent 120 transports itself back to the mobile device 102, and displays information signifying that necessary information has been loaded. The field service technician 130 enters the service vehicle and begins traveling to the day's first scheduled service call.

Once on the road, the mobile device 102 is no longer in range of the Wi-Fi 104 communication medium, and switches to using a cellular communication medium such as GPRS 106 for any necessary communications with the server 134. After finishing a first service call, at 10:15 A.M., and while traveling to a second service call scheduled for 1:00 P.M.—a two hour drive from the first appointment—the mobile device 102 receives a communication through the GPRS 106 communication medium from the server 134 advising of a schedule update. The mobile device 102 sends an agent 120 to the server 134 to acquire the new scheduling information. Upon arrival at the server 134, the agent 120 executes server intensive code 114 to access the new scheduling information from the database 136 and perform other server intensive operations 138 related to the new schedule. The 1:00 P.M. service call has been canceled, but another customer located somewhat more remote, but in the same general area as the previously scheduled appointment has requested service. The new appointment is scheduled for 1:30 P.M., and requires approximately the same travel time.

After acquiring service history and account information from the database 136 for the newly scheduled service call, the agent 120 is transported back to the mobile device 102. Upon arrival at the mobile device 102, the agent 120 updates and displays the new schedule information and the related customer account and product information. The agent 120 then executes the mobile intensive code 112 and determines that the product service manual is needed for the newly scheduled appointment. The agent 120 is then transported back to the server 134 to acquire the needed manual.

Upon acquiring the product service manual from the database 136, preparations are made for transporting the agent 120 and the manual back to the mobile device 102. However, a determination is made that the field service technician's 130 travel to the service call will take him out of cellular range such that only satellite 108 communications will be available approximately half way through the trip. A determination is made that since the manual is relatively small and can be completely transported before the technician is out of range; thus, the cost for transporting the manual over cellular is beneficial and proceeds accordingly.

While on the service call, a new service call is scheduled from the home office, and a determination is made that the field service technician 130 can also handle this call since it is only 45 minutes from the current service call. However, the technician is presently out of cellular range, so a determination is made that satellite will be used to update his schedule. A communication is sent via satellite 108 to the mobile device 102 advising of a schedule change. The mobile device sends an agent 120 to the server through the satellite 108 communication medium to acquire the new schedule. Upon arrival at the server 134, the agent 120 executes the server intensive code 114 and acquires the new schedule and necessary customer information. Further, the agent 120 determines that a two-part technical specification for the product is also required, but the second part is a relatively large file. A cost analysis is performed to determine whether to send the specification to the mobile device 102. The analysis reveals that the field service technician will be back in cellular range part way through the trip to the new service call and that the first part of the specification may be downloaded at that time. Further, the analysis also reveals that a Wi-Fi 104 hot spot is available on the trip path with only a slight detour and that it would be cost beneficial to make the detour so that the second part of the specification may downloaded relatively quickly rather than by the slower and, in this instance, more expensive cellular connection. The satellite 108 communication medium is used only to send the agent 120 back to the mobile device 102 with the new schedule and related information for downloading the technical specification via GPRS 106 and Wi-Fi 104. Upon arrival back at the mobile device 102, the agent 120 displays the new schedule and related customer information.

### TXP2 Protocol

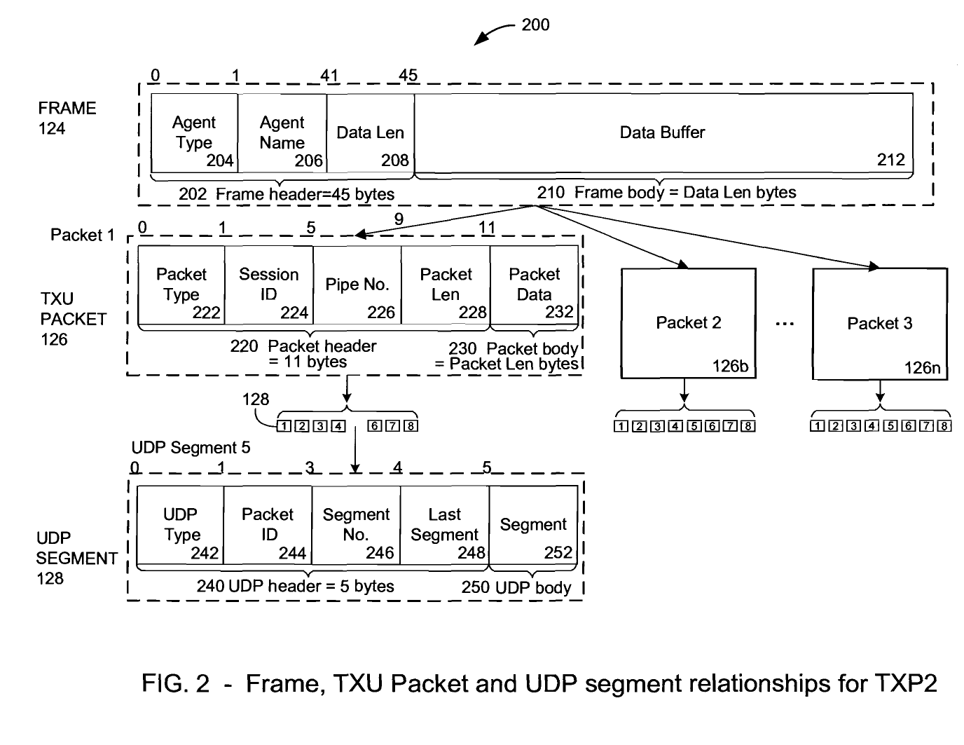

FIG. 2 is a diagram illustrating the primary data structures 200 of the TXP2 protocol. A frame 124 is deconstructed into TXU packets 126, and the TXU packets are divided into UDP segments.

An agent 120, together with any associated file, video, or other data, is converted into a frame 124. Each frame 124 includes a frame header 202 and a frame body 210. The frame header 202 identifies the type of data being transmitted. The frame body 210 contains the information about the agent 120, which includes the data, logic, and/or executable code.

A frame header 202 is 45 bytes and includes an agent type 204, an agent name 206, and a data length 208. The agent type 204 is one byte and identifies whether the agent is real time, batch, or auto. If the agent type 204 is real time, then the agent is meant for real time mode. An agent type 204 batch allows for sending the agent in batch mode. An agent type 204 auto indicates that the agent should be sent in real time, but allows for the agent 120 to be saved to a local database and sent at a later time due to network errors. Agent name 206 is 40 bytes and contains the name of the agent 120. Data len 208 is four bytes and contains the length of the data buffer. The frame body 210 contains the data buffer 212 and contains the actual agent 120 and any data to be sent.

Once the frame 124 is constructed, the TXU (discussed in detail below) divides the frame 124 into TXU packets 126. The TXU packet size is a function of the selected communication medium. For example, a 500 byte packet size is recommended for satellite communications, while a 10 k byte packet size is recommended for GPRS. A packet ID is assigned to each packet.

A TXU packet 126 includes a packet header 220 and a packet body 230. Each packet header is 11 bytes and includes a packet type 222, a session ID 224, a pipe number 226, and a packet length 228. Each packet body 230 includes packet data 232.

The session ID 224 is a number generated by TXP2 using both the user ID and the device ID of the communicating electronic device. (This number uniquely identifies the virtual session that is associated with the virtual space. See below for further discussion of the virtual session and the virtual space) The session ID 224 is unique across TXP2 communication participants.

The TXU packets 126 are divided into UDP segments 128. A UDP segment 128 includes a UDP header 240 and a UDP body 250. Each UDP header 240 is five bytes and includes a UDP type 242, a packet ID 244, a segment number 246, and a last segment 248. Each UDP body 250 includes a segment 252. The size of the segments 252 varies according to the different types of UDP segments 128: probe, ACK, NAK and segment. Only the segment type contains a UDP body 250.

The packet ID 244 identifies the TXU packet 126 to which the UDP segment 128 belongs. Each UDP segment 128 is numbered in order and the segment number 246 identifies the UDP segment 128. The last segment 248 identifies the number of the last UDP segment 128 for a TXU packet 126. The segment 252 includes the actual segment of the data being sent.

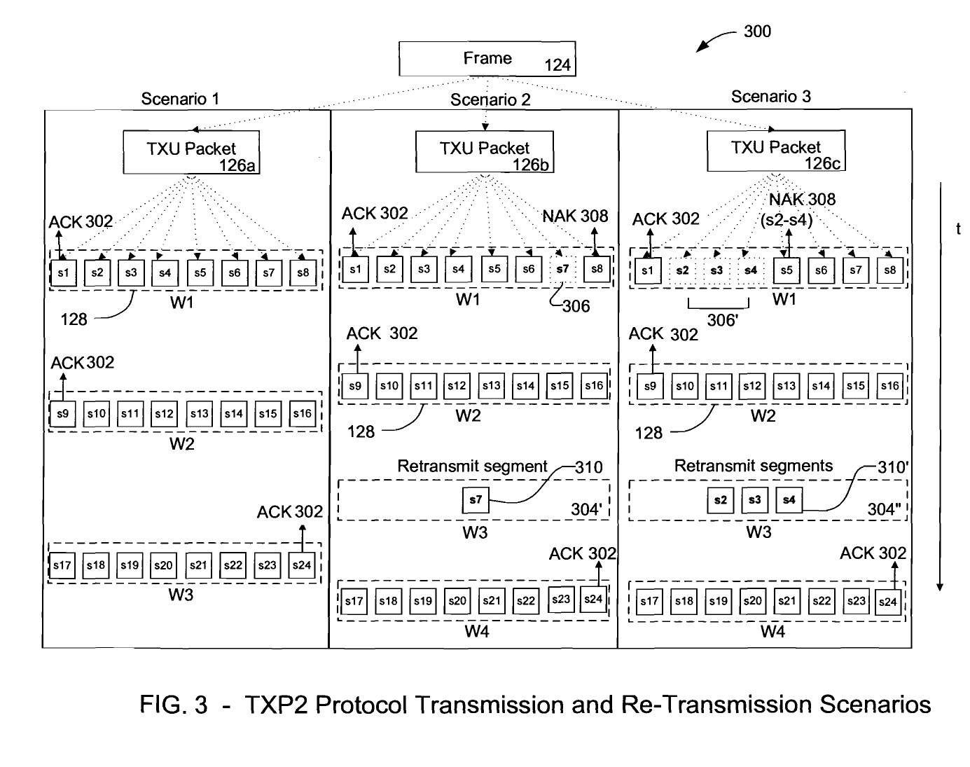

FIG. 3 is a diagram 300 illustrating three scenarios for the transmission of a TXP2 frame 124, TXU packets 126a, 126b, 126c and UDP segments (s1-s24) 128 using a sliding window algorithm as a method of flow control for network data transfers. For purposes of illustration, the example discusses sending data from a mobile device 102 to a server 134, though it should be apparent that data could just as easily be sent from one mobile device 102 to another, from a server 134 to a mobile device 102, from a server 134a to a server 134b, or any other combination of electronic devices. In order to transmit data, TXP2 encapsulates the data into a frame 124. The frame 124 is divided into TXU packets 126a, 126b, and 126c. Each TXU packet 126 is divided into UDP segments 128, s1-s24 in this instance.

TXP2 parameters for packet length, segment length, window length, probe time, probe retry, and receive timeout, among others are included in a TXP2 configuration file. Probe time and probe retry are discussed in further detail in the probe section that follows below. The TXP2 configuration parameters are optimized according to the selected communications medium. Additionally, it should be noted that the selected communication medium can be changed transparently to the electronic devices exchanging data. Part of a frame 124 can be transported using a first medium and the remainder of the frame 124 can be transported using a different medium. Upon determining that the selected communication medium is changing, whether due to availability, or cost concerns, among others, the TXP2 begins using the configuration parameters corresponding to the newly selected communication medium.

Sliding Window

The TXP2 protocol uses a sliding window to send the UDP segments 128 to the receiver. The sliding window algorithm places a buffer between the application program and the network data flow. Using a sliding window, the sender transmits a specified number of data units before expecting to receive an acknowledgement (ACK). The data received is stored in the buffer and an application reads the buffer data at its own pace. As the application reads data it frees the buffer space so that more data is transferred in.

Window Size

A predetermined number of UDP segments 128 are grouped into a window for transmission. The window size corresponds to the number of UDP segments that are sent without waiting for an ACK, and depends upon a combination of the communication medium chosen and the typical transmission error rate for that medium. The number of windows corresponds to the formula:

Number of windows=packet length/(window length*segment length).

Scenario 1

In scenario 1, TXU Packet 126a is divided into UDP segments 128 (numbered s1-s24). The window size in this scenario is 8 UDP segments, therefore the mobile device 102 sender groups 8 UDP segments 128 per window and sends the first window W1 to the receiving server 134. In this scenario, UDP segments s1-s8 of window W1 are received by the server 134. Upon receiving the first segment, s1, of window W1, an ACK 302 is sent to the mobile device 102 so that the next window, W2, can be sent.

Upon receiving the ACK 302, the mobile device 102 begins sending window W2 including the next group of UDP segments 128 (numbered s9-s16) to the server 134. Upon receiving the first segment, s9, of window W2, an ACK 302 is sent to the mobile device 102, so that the next window, W3, can be sent.

Upon receiving the last segment s24 of window W3, an ACK 302 is sent to the sender if all UDP segments for TXU packet 126a have been received. TXP2 determines that the final UDP segment 128 has been received by matching the segment number 246 of the UDP segment 128 with the last segment 248 value. Upon determining that the last segment 248 has been received, a determination is made whether all segments for the TXU packet 126 have been received. If all segments for the TXU packet 126 have been received, then an ACK 302 is sent.

It should be noted that an ACK 302 is not sent after receiving the first segment, s17, of the final window W3 of a TXU packet 126. Rather, a final ACK 302 is sent for the last window after receiving the last segment 248, s24 in this instance. Receipt of the final ACK 302 confirms that the first window of the next TXU packet 126 can be sent.

Scenario 2

In scenario 2, TXU Packet 126b is divided into UDP segments 128 (numbered s1-s24). As above, the window size in this scenario is 8 UDP segments 128, therefore the mobile device 102 sender groups 8 UDP segments 128 per window and sends the first window W1 to the receiving server 134. As in the previous scenario, upon receiving the first segment, s1, of window W1, an ACK 302 is sent to the mobile device 102 so that the next window, W2, can be sent. However, in this scenario, not all UDP segments 128 of window W1 are received by the server 134, but rather there is one missing segment 306 (s7).

Upon receiving the ACK 302, the mobile device 102 begins sending window W2 including the next group of UDP segments 128 (numbered s9-s16) to the server 134. Again, upon receiving the first segment, s9, of window W2, an ACK 302 is sent to the mobile device 102, so that the next window, W3, can be sent.

Upon determining that segment s7 of window W1 has not been received, a NAK 308 is sent to the mobile device 102. The NAK 308 specifies the missing segment number, s7, in the message so that the missing segment 306 (s7) can be resent. A third window W3 that includes only the missing segment 306 (s7) is assembled and then transmitted to the server 134. Of course, window W3 and window W4 could be swapped in order, depending upon when the receiver determines that a UDP segment 128 is missing. For simplicity, in this example, it is assumed that the missing segment 306 is detected before the final window is sent. It should also be noted that the window for retransmitting missing segments 306 typically contains less UDP segments 128 than a typical window, unless an entire window of UDP segments 128 is missing.

Upon receiving the last segment s24 of window W4, an ACK 302 is sent to the sender if all UDP segments 128 for TXU packet 126b have been received. TXP2 determines that the last UDP segment 128 is received by matching the segment number 246 of the UDP segment 128 with the last segment 248. Upon determining that the last segment 248 has been received, a determination is made whether all UDP segments 128 for the TXU packet 126 have been received. If all UDP segments 128 for the TXU packet 126 have been received, then an ACK 302 is sent.

It should be noted that an ACK 302 is not sent after receiving the first segment, s17, of the last window W4. Rather, a final ACK 302 is sent for the last window after receiving the last segment, s24 in this instance. Receipt of the final ACK 302 confirms that the first window of the next TXU packet 126 can be sent.

Scenario 3

In scenario 3, TXU Packet 126c is divided into UDP segments 128 (numbered s1-s24). As above, the window size in this scenario is 8 UDP segments 128, therefore the mobile device 102 sender groups 8 UDP segments 128 per window and sends the first window W1 to the receiving server 134. As in the previous scenario, upon receiving the first segment, s1, of window W1, an ACK 302 is sent to the mobile device 102 so that the next window, W2, can be sent. However, in this scenario, not all UDP segments 128 of window W1 are received by the server 134, but rather there are three missing segments 306′ (s2, s3, and s4).

Even though segments s2, s3 and s4, were not received, the receiver sends an ACK 302 upon receiving the first segment, s1, of window W1. Thus, the sender can begin sending the next window, in this case, window W2. When the sender receives the ACK 302, the sender begins to send window W2 to the receiver with the next group of UDP segments s9-s16.

Upon receiving segment s5 and determining that segments s2,s3, and s4, have not been received, a NAK 308 is sent to the mobile device 102. The NAK indicates that segments s2, s3, and s4 are missing and should be resent. A NAK is not necessary for each UDP segment 128, but rather if multiple UDP segments 128 are determined missing simultaneously—as in receiving segment s5 after segment s1—a single NAK suffices for the entire group of missing segments. Upon receiving the NAK indicating missing segments s2, s3, and s4, a window W3 containing the three missing segments 306′ is assembled and segments s2, s3, and s4 are retransmitted to the server 134.

Upon receiving the first segment s9 of window two W2, the receiver sends an ACK 302 so that the sender can send the next window, in this case, W4.

Upon receiving the last segment s24 of window W4, an ACK 302 is sent to the sender if all UDP segments for TXU packet 126c have been received. TXP2 determines that the last segment is received by matching the segment number 246 of the UDP segment 128 with the last segment 248. Upon determining that the last segment 248 has been received, a determination is made whether all segments for the TXU packet 126c have been received. If all segments for the TXU packet 126 have been received, then an ACK 302 is sent.

As above, it should be noted that an ACK 302 is not sent after receiving the first segment, s17, of the last window W4. Rather, a final ACK 302 is sent for the final window after receiving the last segment, s24 in this instance. Receipt of the final ACK 302 confirms that the first window of the next TXU packet 126 can be sent.

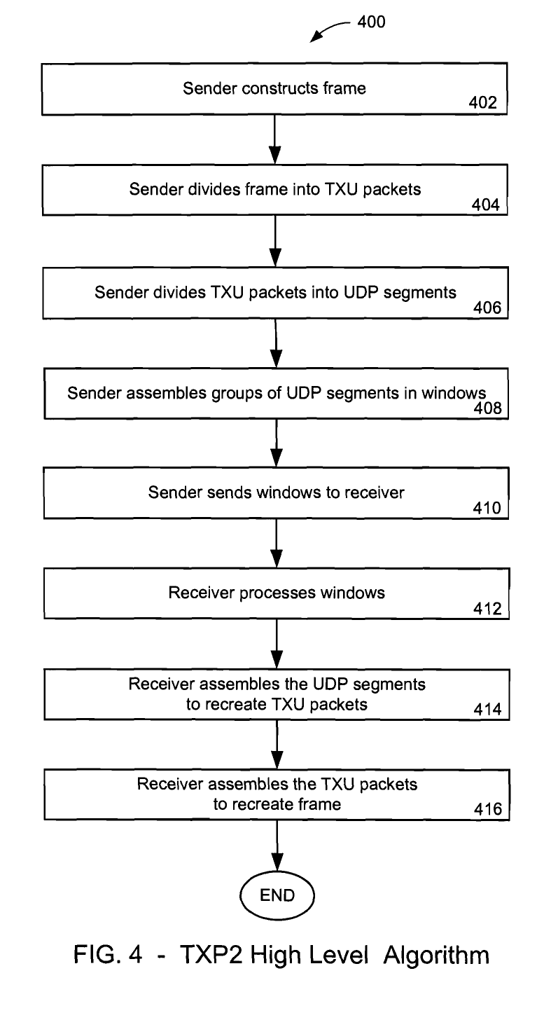

FIG. 4 is a high level illustration of the TXP2 algorithm 400. Briefly, the flowchart shows that a frame 124 is deconstructed and sent to a receiver where it is reassembled. At step 402, the sender constructs a frame 124 from agent data typically received from an application. At step 404, the sender divides the frame into TXU packets 126, and at step 406, the TXU packets 126 are divided into UDP segments 128. At step 408, the UDP segments 128 are assembled into windows for transmission to the receiver at step 410.

Next, the data arrives at the receiver. At step 412, the receiver processes the received windows one UDP segment 128 at a time. At step 414, the TXU packets 126 are recreated by reassembling the UDP segments 128. Finally at step 416, once all the TXU packets 126 are received, the frame 124 is recreated.

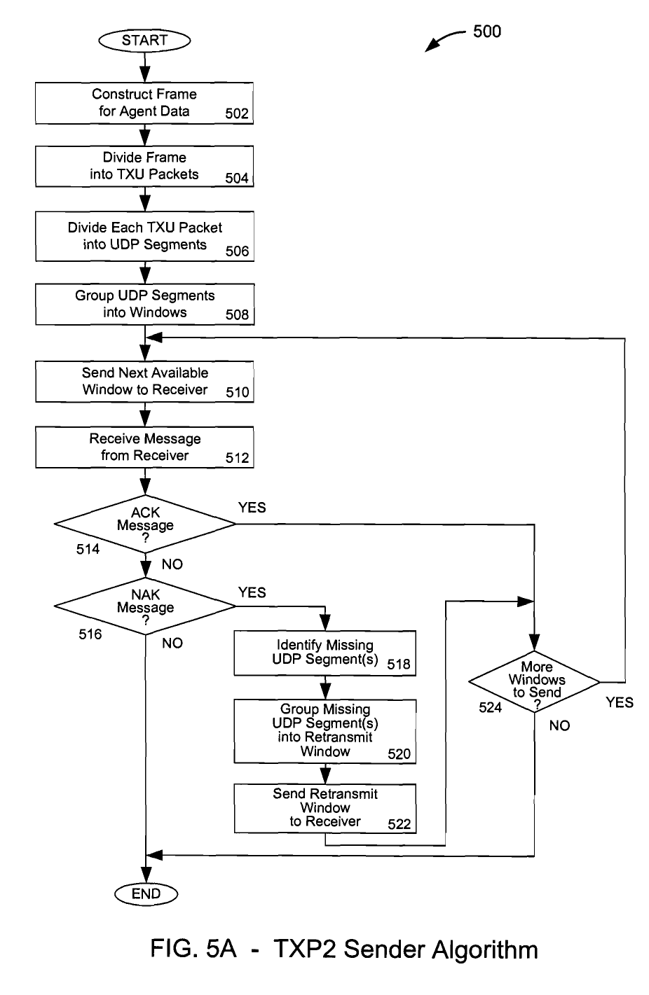

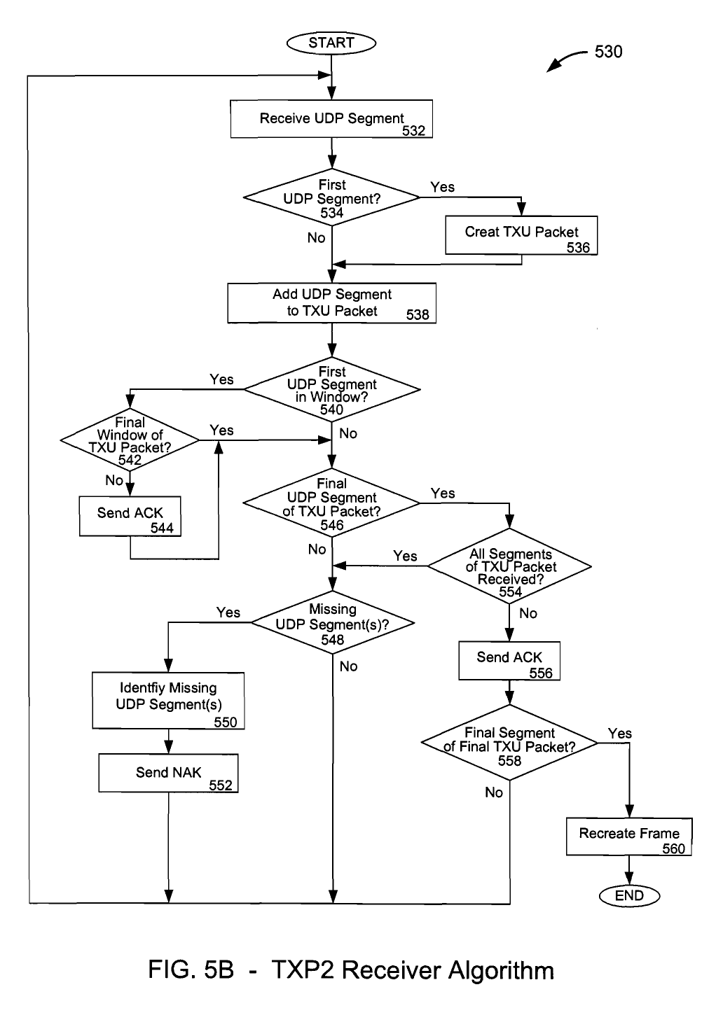

FIG. 5A is a detailed flowchart 500 of the TXP2 algorithm for sending data over a wireless communication or other network. Data is transmitted from one computing device, such as a remote electronic device 102 or handheld computer, to another computing device, such as a server or another handheld computer for example, through a selectable communication medium. At step 502, the data is constructed into a frame 124 for the agent data, for example, at the first computing device. Next at step 502, the frame 124 is divided into TXU packets 126. Each TXU packet 126 is divided into a plurality of UDP segments 128 at step 506. Before sending the UDP segments 128 to the receiving computing device, the UDP segments 128 are grouped into a plurality of windows at step 508. Each window contains a predetermined number of UDP segments 128, and the predetermined number of UDP segments 128 is determined according to the selectable communication medium. At step 510, a window is sent to the receiving computing device, one UDP segment 128 at a time. The window being sent could be the first window of the TXU packet 128, but of course, could also be the next available window until all the windows for a TXU packet 128 are sent to the receiving computing device.

At some point after sending the first UDP segment 128 of a window, the sending computing device will typically receive an ACK 302 or NAK 308 message from the receiving computing device at step 512. At step 514, a determination is made whether the received message is an ACK 302. An ACK 302 indicates that the receiving computing device has received the first UDP segment 128 of a window, unless the window is the final window of a TXU packet 126. For the final window of a TXU packet 126, an ACK 302 is only received from the receiving computing device once all UDP segments 128 for the TXU packet have been received. Upon receiving an ACK 302 corresponding to the first UDP segment 128 of a window, the sending computing device may begin sending the next available window. Thus, if an ACK 302 message is received, a determination is made whether there are any more windows to send at step 524. If more windows remain to be sent, the process returns to step 510 and continues sending the UDP segments 128 for the next available window. If no windows remain to be sent, then the ACK 302 indicates that all UDP segments 128 for the TXU packet 126 have been successfully received at the second computing device, and that the sending of windows is at an end. Of course, the process will begin again for the next TXU packet 126.

If the received message is not an ACK 302, then a determination is made at step 516 whether a NAK 308 was received. A NAK 308 indicates that at least one UDP segment 128 was not received by the receiving computing device. The NAK 308 also identifies the missing UDP segment 128 or segments. At step 518, the sending computing device acquires the information for identifying the missing UDP segment 128 or segments. The missing UDP segment(s) 128 are grouped into a retransmit window at step 520 and then the retransmit window is sent to the receiving computing device at step 522. After sending the retransmit window, a determination is made, at step 524, whether more windows remain to be sent.

FIG. 5B is a detailed flowchart 530 of the TXP2 algorithm for receiving data over a wireless communication or other network. Data is received from one computing device, such as a remote electronic device 102 or handheld computer, to another computing device, such as a server 134 or another handheld computer for example, through a selectable communication medium. A UDP segment 128 is received at step 532. Next, a determination is made at step 534, whether the UDP segment 128 is the first UDP segment 128 of a TXU packet 126. For a first UDP segment 128, a new TXU packet 126 is created at step 536, and the UDP segment 128 is added to the TXU packet 126 at step 538. Of course, if the received UDP segment 128 is not a first segment, it is still added to the TXU packet 126 at step 538.

At step 540, a determination is made whether the UDP segment 128 is the first segment in a window. If the UDP segment 128 is the first UDP segment 128 in a window, then a determination is made at step 542, whether it is also the first UDP segment 128 in the final window of a TXU packet 126. If the first UDP segment 128 is the first UDP segment 128 in the final window of a TXU packet 126, then no ACK 302 is sent by the receiving computing device. However, if the UDP segment 128 is the first UDP segment 128 of a window prior to the final window, then an ACK 302 is sent by the receiving computing device. ACKs 302 are sent after the first UDP segment 128 of each window except the final window of a TXU packet 126. In either event, at step 546, a determination is made whether the UDP segment 128 is the last segment 248 of a TXU packet 126. The determination whether the UDP segment 128 is the final segment of a TXU packet 126 is made by comparing the segment number 246 against the last segment 248 value.

If the received UDP segment 128 is the final UDP segment 128 of a TXU packet 128, then a determination is made whether the TXU packet 126 is complete at step 554. If all UDP segments 128 for the TXU packet 126 have been received, then an ACK 302 is transmitted to the sending computing device at step 556. If all UDP segments 128 for the TXU packet 126 have not been received, then processing continues by checking for missing UDP segments 128 at step 548.

Once all UDP segments 128 of a TXU packet 126 have been received and the corresponding ACK 302 is sent at step 556, a determination is made whether all UDP segments 128 for all TXU packets 126 have been received. At step 558, the determination is made whether the received UDP segment 128 is the final UDP segment 128 of the final TXU packet 128. If so, then the frame 124 is recreated from the received TXU packets 126.

Returning to step 546, if the received UDP segment 128 is not the last UDP segment 128 of a TXU packet 126, then processing continues at step 548 to determine whether any UDP segments 128 are missing (were not received as expected). UDP segments 128 from a window are transmitted sequentially from a sending computing device, and are typically received sequentially at the receiving computing device. The segment number 246 of a received UDP segment 128 can be compared, for example, against the segment number 246 of the last received UDP segment 128, or against the segment number 246 of the last UDP segment 128 added to the created TXU packet 128, to determine whether the numbers are sequential, and thus, whether one or more UDP segments 128 have not been received.

Upon determination that one or more UDP segments 128 are missing at step 548, the missing UDP segment(s) 128 are identified at step 550, and then a NAK 308 is sent, at step 552, from the receiving computing device to the sending computing device. The NAK 308 also identifies the missing UDP segment(s) 128, and the receiving computing device then continues to receive UDP segments 128 at step 532.

If no missing UDP segments 128 are detected then the receiving of UDP segments 128 continues at step 532 until each TXU packet 126 is received and the frame 124 is recreated.

### TXP2 Dual Protocol

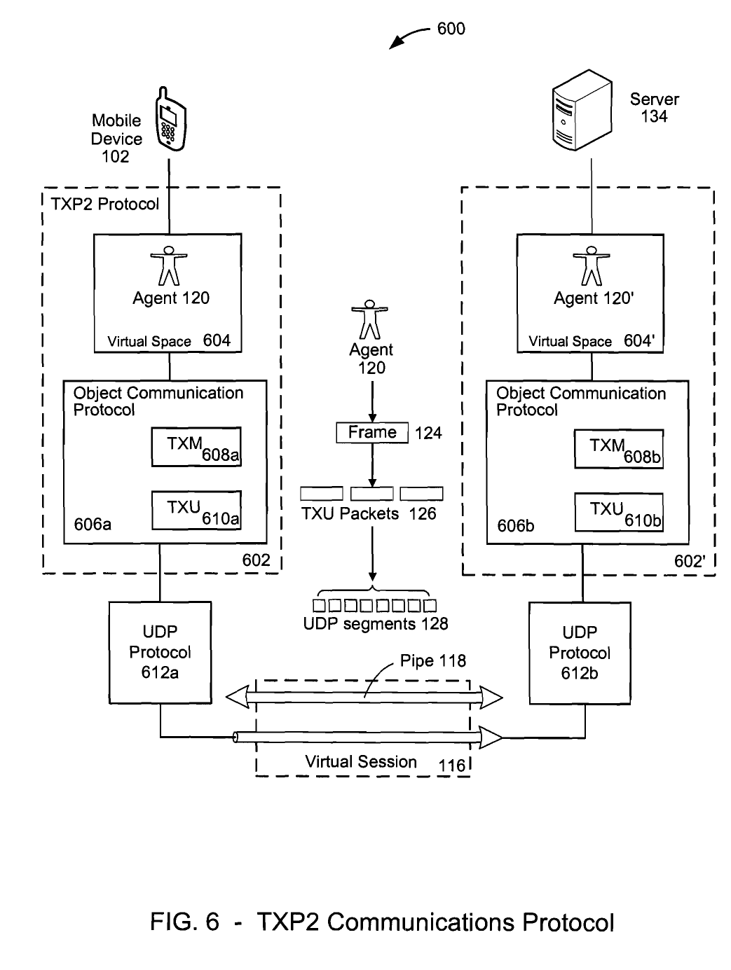

FIG. 6 is an overview of exemplary aspects of the TXP2 communications protocol functionality 600. A mobile device 102, such as a handheld computer for example, communicates with a TXP2 server 134 using the TXP2 protocol 602 over a selected communication medium. The TXP2 protocol 602 deconstructs an agent 120 from a virtual space 604 using a two level object communication protocol (OCP) 606a. The OCP 606a deconstructs the agent 120 into the frame 124, TXU packets 126, and UDP segments 128, which are then transmitted from the mobile device 102 to the TXP2 server 134 over the selected medium via the UDP protocol 612a. The UDP protocol 612a at the mobile device 102 controls the actual transmission of the UDP segments 128 through a designated pipe 118 of a virtual session 116 to the TXP2 server 134 where receipt of the UDP segments 128 is controlled by the UDP protocol 612b. Of course communications through the pipe 118 have full duplex capability, and therefore it should be noted that the TXP2 server 134 also has capability for sending the agent 120 back to the mobile device 102 through a pipe 118 in the virtual session 116.

The UDP protocol 612b at the TXP2 server 134 receives UDP segments 128 through a pipe 118 (within the virtual session 116). The OCP 606b assembles the UDP segments 128 into TXU packets 126 to recreate the frame 124 and reconstruct the agent 120′ within the virtual space 604′ at the TXP2 server 134.

The object communication protocol 606 uses a dual protocol technology and includes two protocols TXM 608 and TXU 610 for transmitting agents over the selected communications networks. TXM 608 is a universal application protocol. Whereas TCP/IP requires applications to provide application methods for managing the communication process, the TXM 608 protocol unburdens applications from managing an application protocol, and improves overall communication efficiency and performance. The improved efficiency and performance is especially significant when applied to both wired and wireless communications

The TXM 608a deconstructs the agent 120 into a frame 124, subdivides the frame into multiple TXU packets 126, and hands off the TXU packets to the TXU 610 one packet at a time. The TXM 608a also constructs a virtual session 116 with the TXM 608b running on the TXP2 server 134, and allocates a pipe 118 within the virtual session 116. After the frame 124 is sent, the pipe 118 is closed.

Additionally, the TXM has the ability to probe the agent periodically, to check the status of the agent. The TXM typically probes the agent, for example at one minute intervals, to inquire as to agent status and to verify that the system is working properly. Probe functionality is discussed in greater detail below.

The TXU 610a at the mobile device 102 uses a negative acknowledgement window protocol to send each TXU packet 126 to the TXU 610b at the TXP2 server 134. TXU provides guaranteed delivery of the frame data (agent 120) using UDP for transmission of segments. UDP is a connectionless protocol that supports sending small fixed size segments. TXU 610 uses the sliding window algorithm described above to implement segmentation and reassembly. TXU packets 126 are divided into segments that are transmitted individually and reassembled upon being received. Since the communication is connectionless, segments are sometimes lost, delivered out of order, or delivered multiple times. By windowing the segments and providing acknowledgments of received segments and retransmissions of missing segments, the TXU 610 protocol assures that only whole packets are sent and received.

Upon receiving the UDP segments 128, reconstruction of the TXU packets 126 begins. The reconstructed TXU packets 126 are then used to reconstruct the frame 124. When a TXU packet 126 has arrived, the TXU 610 notifies the TXM 608. If the TXU packet 126 is the first packet of the frame 124, the TXM 608 attempts to create the frame 124. If the TXU packet 126 is the last packet of the frame 124, the TXM attempts to create the agent 120 using the information from the virtual space 604.

The TXP2 dual protocol provides several advantages over traditional single protocol transmission methods. The TXP2 dual protocol is simpler to implement and maintain (two simple protocols) than a single complex protocol. Each of the two protocols can be changed without impacting the other protocol. A TXM 608 module is easily implemented using only one thread, while TXU 610 modules are typically implemented using two threads, thus TXP2 requires only three threads to support an unlimited number of virtual sessions 116.

### Agents

Mobile agents 120 are data communication objects containing both data and executable code necessary for performing specific tasks on a computer or other computerized device. Agents utilize the TXP2 protocol to travel from one computer to another. Agents 120 contain both data and logic necessary for performing a task on a computer or other electronic device. Further, agents 120 can perform tasks at the receiving computer or electronic device with complete independence from the sending device.

The agent 120 may perform a number of related tasks, portions of which are executed at different locations. For example, a mobile device 102 in use by a field service technician 130 may require both a customer history, and a product schematic diagram. If the customer history has already been acquired previously, then it may be displayed for the technician. However, if the product schematic diagram is not available within the mobile device, then an agent 120 will be sent to a TXP2 server 134 to retrieve it from a database 136.

Programming considerations consider the decisions as to availability of resources and communication media for performing the task at hand. The agent 120 contains the entirety of executable code for performing such tasks as displaying file data on the handheld, and retrieving the file data from a database. However, the entirety of functionality cannot be performed in all locations where the agent 120 may be located. For example, if an agent 120 is operating on a mobile device 102, and reaches a point in the code where the product schematic diagram must be retrieved from a database, a determination is made that the database retrieval code is server intensive 114 code and the agent must transport to the server 134 to retrieve the file. If network connectivity is available, then the agent 120 transports to the server 134, acquires the file, and returns to the handheld.

In some instances, network connectivity may not be available, whether due to network outages or cost considerations for the price of certain types of connections. In those circumstances, the agent 120 either executes other functionality while monitoring for connectivity to complete the previous task, passes control to another agent to execute other desired functionality, or waits until connectivity is available, for example. The determination whether to perform other functionality or wait is, of course, design and functionality dependent.

TXP2 sends and receives agents 120 over a selectable communication medium, including wired networks such as for example, LAN, and WAN, and wireless networks such as Wi-Fi, GPRS, CDMA, GSM, and satellite, for example. Objects written in any programming language can become an agent 120 by using the following exemplary callback functions: (1) OnGetAgentType, (2) OnGetAgentName, (3) OnGetSendData (Data Len, Data Buffer), (4) OnPutSendData (Data Len, Data Buffer), (5) OnArrived, (6), OnGetReturnData (Data Len, Data Buffer), (7) OnPutReturnData (Data Len, Data Buffer), and (8) OnReturned. Of course, those of skill in the art will readily note that many other callback functions could also be defined.

The OnGetAgentType function returns a byte denoting whether the agent is to be sent in 1=real time, 2=batch, or 3=auto. A value of ‘real time’ signifies that the agent 120 is intended to be sent in real time mode. An application on a sending computer sends an agent 120 to a second computer, and the second computer may optionally return the agent 120 to the sending computer. In either case, the sending computer's application waits for completion of the transport process before continuing execution.

A value of ‘batch’ signifies that the agent 120 is intended to be sent in batch mode. An application on a computer sends an agent 120 to a second computer. The first computer's TXM 608 module tracks the state of the transmission, but not the execution. The application continues execution without waiting for status updates on the transport process.

A value of ‘auto’ signifies that the agent 120 is intended to be sent in real time, but if the agent 120 failed to send due to network errors, it is saved to the local database and sent at a later time. An application on a computer sends an agent 120 to an application on a second computer. The TXM 608 module determines whether real time mode is possible based on network conditions. If real time mode is possible a real time transport begins and the sending application is notified. Otherwise, the TXM 608 begins a batch mode process and the sending application is notified. Thus, the application needs wait if real time mode is possible, but not otherwise.

The OnGetAgentName function returns the name of the agent and contains up to 40 bytes.

The OnGetSendData (Data Len, Data Buffer) function is called by TXP2 before sending an agent 120. The function returns a pointer to Data Len, the number of bytes in the Data Buffer, and a pointer to Data Buffer, the buffer containing the data to be sent with the agent.

The OnPutSendData (Data Len, Data Buffer) function is called by TXP2 after the agent has arrived at the destination. TXP2 will pass in both Data Len and Data Buffer.

The OnArrived function is notifies that the agent 120 has arrived at the destination. This function is called after OnPutSendData and processes the sent data.

The OnGetReturnData (Data Len, Data Buffer) function is called before TXP2 returns the agent 120 if the agents was sent using real time mode. The function returns Data Len, a pointer to the number of bytes in the Data Buffer, and also returns Data Buffer, a pointer to a buffer containing the data to be returned with the agent 120.

The OnPutReturnData (Data Len, Data Buffer) function is called after the agent 120 arrives at the destination. The function passes in a pointer to Data Len, the number of bytes in the Data Buffer, and a pointer to Data Buffer, the buffer containing the data to be sent with the agent which were obtained from the OnGetSendData function.

The OnReturned function notifies that the agent 120 has returned. This function is called after the OnPutReturnData function and contains logic to process the returned data.

### Virtual Space

A virtual space 604 at each computing device (mobile device 102 and TXP2 server 134 in FIG. 6) provides execution context for mobile data communication objects, such as agents, to perform specified computing tasks. The virtual space on a sending computing device is used by TXP2 to deconstruct the agent 120 into a frame 124 for transmission through the selected communication medium. At the receiving computing device, TXP2 uses the virtual space 604 to reconstruct the agent 120.

The virtual space 604 is an information object maintained on each communicating computing device, and contains the information necessary for constructing the agent 120 and its execution context. Upon determination that an agent is to be transported from one computer to another through the selected communication medium for example, a virtual session 116 is opened between the TXM 608 modules on the two computers. If the communication is the first time that the first computer has sent an agent 120 to the second computer, the virtual space 604 from the sending computer is recreated at the receiving computer. Thus, the agent 120 operates within the same effective virtual space 604 on both computers.

A mirror of the virtual space 604 from the sending application (on the sending computer) is created by TXP2 on any computers to which the application transports agents 120. Identical virtual spaces 604 on sending and receiving computers allows for synchronization of the information between these virtual spaces 604. Thus, TXP2 need not send all the information necessary to reconstruct and execute the agent 120. Rather, only the unique data of the agent instance is transmitted, resulting in smaller amounts of data being sent between computing devices. The entire execution context and code need not be sent with each transmission.

The first time that an agent 120 is transported, the agent information is stored in the agent list of all related virtual spaces 604. For subsequent transportations of the agent 120, only the new information for that particular agent instance need be sent. The data is typically compressed and encrypted before transmission. The compression efficiency is enhanced due to the compression table resulting from the first compression of a particular agent that is also stored and maintained across multiple virtual spaces 604.

Caching of the virtual space 604 decreases the usage of main memory at the communicating computers. The caching is accomplished by using an in-memory table of virtual spaces 604 stored in the local memory of each communicating computer. Of course, the table size is configurable. The caching is accomplished by maintaining the current active virtual space 604 in the table and swapping out the least used virtual spaces 604 to the local database. With virtual space caching, it is possible for a computer to support an unlimited number of users.

The virtual space 604 contains the information necessary for the transfer and execution of agents 120, including (1) a version ID, (2) a session ID, (3) a user ID, (4) a device ID, (5) an encryption key, (6) an IP address, (7) an IP port number, (8) status, (9) an agent list, (10) a frame list, (11) an error code, and (12) an error message.

A version ID contains the version number of the virtual space 604. TXP2 uses the version number to communicate with different versions of TXP2 that are running on the electronic devices that are communicating.

The session ID is generated by TXP2 using both the user ID and the device ID of the communicating electronic device. The session ID uniquely identifies the virtual session 116 that is associated with the virtual space 604. The session ID is unique across TXP2 communication participants so long as the device ID is unique.

The user ID is provided by the application at the computing device associated with this particular virtual space 604.

The device ID is provided by the application, or alternately generated by TXP2.

The encryption key is generated and exchanged using Diffie-Hellman key exchange.

The IP address contains the network address of the local electronic device that is running the TXP2 module.

The IP port number contains the network port number.

The status contains the status of the virtual space 604.

The agent list contains a list of the agents 120.

The frame list contains a list of frames 124 waiting to be sent or received at the local electronic device.

The error code contains the latest error code for any errors that occurred during the transport process.

The error message contains the latest error message for any errors that occurred during the transport process.

### Virtual Session

A virtual session 116 is a communication context between the virtual spaces 604 of respective communicating computers across a selected communication medium. The communication channel allows full duplex capability for agents 120 to transport between specified applications, independent of underlying IP and port address changes of the communicating nodes. Applications on computers or other electronic devices may send and receive agents 120 over any IP based network simultaneously. One virtual session 116 allows an application to communicate to any TXP2 enabled computers whereas TCP/IP communications require two sockets for each pair of communicating computers.

The virtual session 116 maintains the communication context between virtual spaces 604 on different computers independently of the underlying physical network. For example, TXP2 can continue transmission of data from one computer to another while switching from a Wi-Fi to a GPRS network and the IP address and port number changes that result.

TXP2 automatically notifies other communicating computes that its IP network and port have changed.

Each virtual session 116 can have multiple full duplex communication pipes 118, thus enabling an application to send and receive data to any number of TXP2 enabled computers simultaneously. Pipes 118 are created for communications between computers or other computing devices. A pipe 118 is allocated within a virtual session 116 and typically connects two devices to provide for the transmission of UDP segments 128 over IP. A pipe is typically used for the communication of a single frame—single data entity or object—and is terminated and release once the communication is completed.

The virtual session 116 typically operates over a wireless communication medium, though any network that uses IP will suffice.

Additionally, the communication medium through which the virtual session 116 operates is selectable and changeable. For TXP2, the frame size, the TXU packet size, the UDP segment size, and the window groupings for UDP segments are optimized according to the communication medium. For example, a field service technician 130 on the way to a service call typically receives updates at a mobile device 102, such as a handheld computer, through multiple wireless networks. TXP2 adjusts for the different cellular networks and/or satellite network as the mobile device moves from one geographical area to another. Even though the underlying IP address and port numbers change, the communications typically continue transparently to the mobile device 102 and the other communicating computer.

A configuration file contains values optimized for the various communication media that may be selected by TXP2 for communications. The configuration file includes the following TXP2 protocol parameters: (1) packet length, (2) segment length, (3) window length, (4) probe time, (5) probe retry, and (6) receive timeout. The parameters are either set by the application, or TXP2 automatically determines the values based on the wireless network type, bandwidth, latency, and error rates.

The packet length 228 indicates the size of the TXU packet 126. The TXM 608 subdivides the frame 124 into multiple TXU packets 126 having size equal to the packet length.

The segment length 248 indicates the size of the UDP segment 128. The TXU 610 subdivides each TXU packet 126 into multiple UDP segments 128 having size equal to the segment length.

The window length indicates the number of UDP segments 128 that the TXU 610 sends before an ACK 302 is required. An ACK 302 is sent after the first UDP segment 128 of each window, excepting the last window. An ACK 302 is sent after the final segment of the last window is received so long as all UDP segments 128 for the TXU packet 126 have been received.

The probe time (discussed in greater detail below) indicates the time in seconds that the TXU 610 waits for an ACK 302 before probing the receiver.

The probe retry indicates the maximum number of probe retries performed by the TXU 610 before returning an error to the TXM 608.

The receive timeout indicates the time in seconds that the TXU 610 waits for the next UDP segment 128.

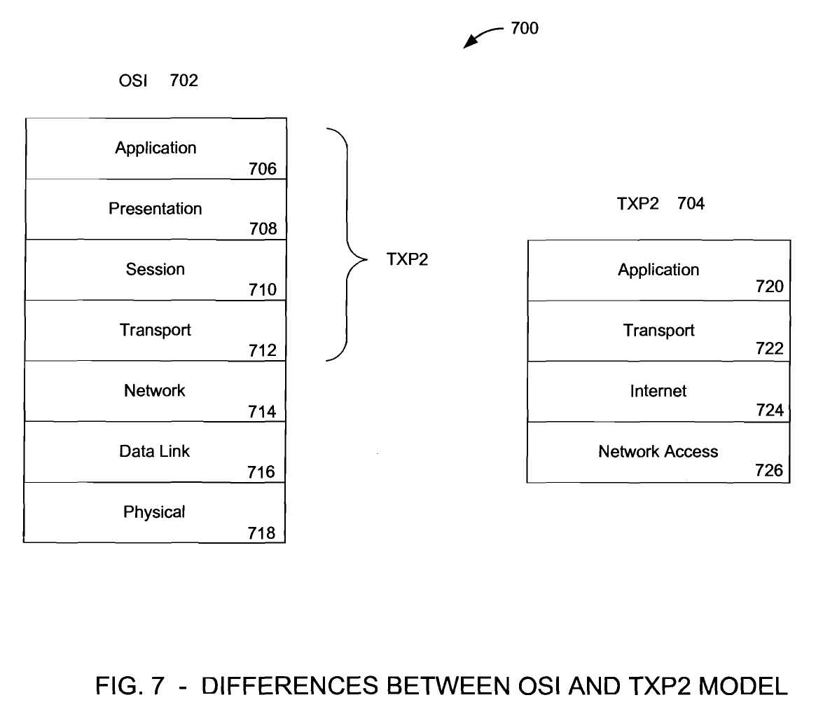

FIG. 7 is an illustration of the difference 700 between the Open Systems Interconnection Basic Reference Model (OSI Reference Model or OSI Model) 702 and TXP2 communications protocol 704. The OSI model 702 is a seven layered, abstract description for communications and computer network protocol design. The OSI layers are application 706, presentation 708, session 710, transport 712, network 714, data link 716 and physical layer 718. Both TCP/IP and TXP2 704 use only 4 of the OSI layers: application 720, transport 722, Internet 724 and network access 726. The application layer in TCP/IP and TXP2 724 handles responsibilities comparable to the presentation 708 and session 710 layer in the OSI model 702.

### Probe

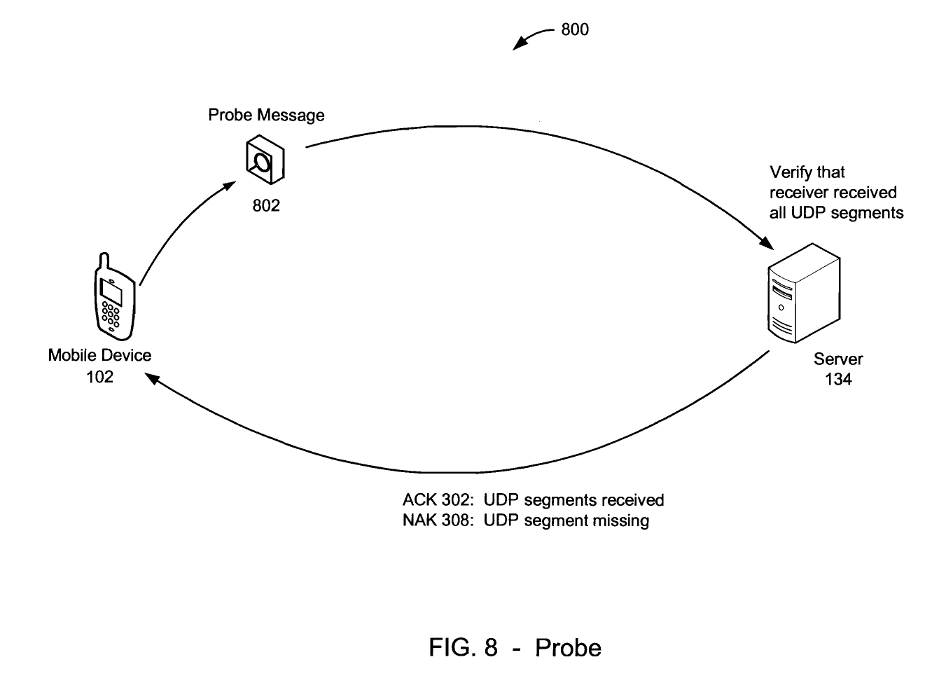

FIG. 8 illustrates probe functionality 800 for mobile data object transmission using the TXP2 object communication protocol. A second frame 124 is only sent after the first frame is complete. Upon not receiving a final ACK 302, probe functionality allows the sending computer to inquire as to whether all UDP segments 128 were received. Probe messages 802 may be sent, for example, from a mobile device 102 to a server 134 if it appears that UDP segments 128, ACKs 302, or NAKs 308 are not being received. Of course, the server 134 may also send probe messages 802 to the mobile device 102 for the same reason.

A configuration file contains values for a probe time and a probe retry count. UDP segments 128 may often be lost or out of order when received. Additionally, ACK 302 and NAK 308 messages may also be lost.

Upon sending UDP segments 128, an ACK 302 or NAK 308 is expected after a reasonable time to indicate either that the first UDP segment 128 of a window was received, or that one or more UDP segments 128 were missing from the transmission. The probe time value indicates how long a sender should wait before sending a probe message 802 to the receiver. The probe time is configurable, thus, probe functionality is not based on a timeout, but rather on receiving or not receiving a response, such as an ACK 302 or a NAK 308, to the probe message. A UDP segment 128 of type ‘probe’ is sent as a probe message 802 to inquire whether the sender is still there and whether the UDP segments 128 were received. Additionally, if the probe message 802 itself is not received, then the sender sends a probe message 802 again. The probe retry parameter indicates how many times to resend a probe message 802 before reporting an error to the TXU 610. Again, timing is not an issue, but rather whether or not responses are received to the probe message.

ACK 302 and NAK 308 messages may also be lost when sent from the receiver to the sender. After receiving the first UDP segment of a window, the receiver sends an ACK 302 to let the sender know to begin sending the next window. (This indicates that the first UDP segment 128 was received, the communication channel is functioning, and to continue sending the messages. It also provides modest interim feedback during the transmission of data.) Upon sending an ACK 302 after receiving the first UDP segment 128 of each window (excepting the last window of a TXU packet 126), the receiver expects to continue receiving segments until the TXU packet 126 is complete, at which time another ACK 302 is sent.

The receiver may also send a probe message to the sender if an expected retransmission of UDP segments does not occur. If a previously received UDP segment 128 was missing (indicated by receiving a UDP segment 128 before another expected UDP segment 128, for example receiving segment 4 prior to receiving segment 3), then the receiver sends a NAK 308 to the sender. The NAK 308 identifies the UDP segment 128 that was missing. Upon sending the NAK 308, the receiver expects to subsequently receive a transmission containing the missing UDP segment 128. If the missing UDP segment 128 is not received, then the receiver will send a probe message 802 after waiting the time specified by the probe time value. If the missing UDP segment 128 is still not received after waiting again for the time according to the probe time value, the receiver sends another probe message 802. Again, the probe retry parameter specifies how many times the receiver sends a probe message 802 before reporting an error to the TXU 610.

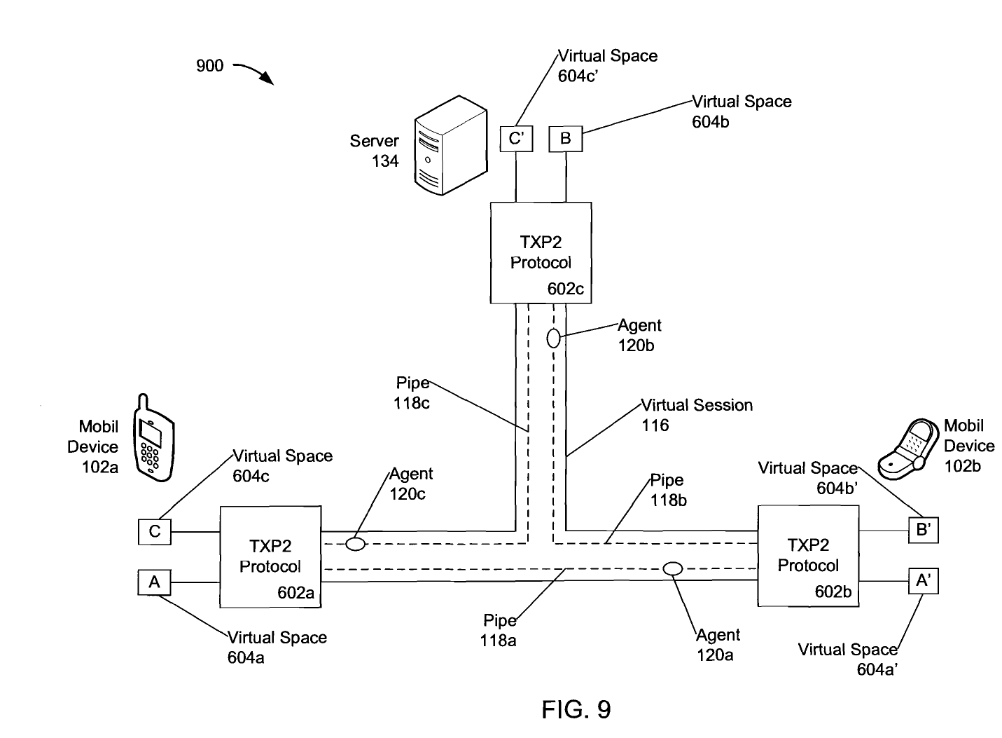

FIG. 9 illustrates a mobile data object transmission system 900 that uses the TXP2 communications protocol for multiple devices. The TXP2 object communications protocol allows for communications between multiple computing devices. The virtual space 604 for a particular agent 120 is replicated at each computing device where that agent 120 operates. Additionally, a virtual session 116 provides a channel of communication between a computing device, such as a mobile device 102a, and each of the computing devices to which the agent 120 transports. A pipe 118 provides full duplex connectivity between the computing devices.

In one embodiment, an application C at mobile device 102a requires connectivity with application C at server 134. The TXP2 protocol 602a creates a virtual space 604c at mobile device 102a and TXP2 protocol 602c creates a corresponding virtual space 604c′ at server 134. For communications between Applications C at mobile device 102a and server 134, the agent 120c may then transport from mobile device 102a to the server 134 using pipe 118c that is allocated through the virtual session 116.

Similarly, another application A at mobile device 102a also requires connectivity with application A at mobile device 102b. The TXP2 protocol 602a creates a virtual space 604a at mobile device 102a and TXP2 protocol 602b creates a corresponding virtual space 604a′ at mobile device 102b. For communications between Applications A at mobile device 102a and mobile device 102b, the agent 120a may then transport from mobile device 102a to mobile device 102b using pipe 118a that is allocated through the virtual session 116.

Further, another application B at server 134 requires connectivity with application B at mobile device 102b. The TXP2 protocol 602c creates a virtual space 604b at server 134 and TXP2 protocol 602b creates a corresponding virtual space 604b′ at mobile device 102b. For communications between Applications B at server 134 and mobile device 102b, the agent 120b may then transport from server 134 to mobile device 102b using pipe 118b that is allocated through the virtual session 116.

A virtual space 604 is allocated at as many locations as necessary for agent 120 transport between the respective computing devices at those locations. A pipe 118 is allocated for a specific communication between two computing devices and is release when that communication is complete. However, a virtual session 116 may contain many pipes 118 between any number of computing devices that communicate through the virtual session 116.

The foregoing description of the exemplary embodiments of the inventions have been presented only for the purposes of illustration and description and is not intended to be exhaustive or to limit the invention to the precise forms disclosed. Many modifications and variations are possible in light of the above teachings.

### OTHER ASPECTS OF THE INVENTIONS

The following are additional aspects and statements of the inventions.

Aspect 1 (Communication): Methods and Systems for data communication between multiple computing devices.

1. A method for data communication between a remote electronic device and a server, comprising steps of:
at the remote electronic device:
transmitting data through a selectable communication medium to the server, further comprising:
   constructing a frame for data, the frame comprising a frame header and a frame body, the frame header including an agent type, an agent name, and a data length, and the frame body including a data buffer corresponding to the data length;
   dividing the frame into a plurality of TXU packets that collectively comprise the frame body, wherein a TXU packet from the plurality of TXU packets comprises a packet header and a packet body, the packet header including a packet type, a session ID, a pipe number, and a packet length, and the packet body including packet data corresponding to the packet length;
   dividing the TXU packet into a plurality of UDP segments, wherein a UDP segment from the plurality of UDP segments comprises a UDP header and a UDP body, the UDP header including a UDP type, a packet ID, a segment number, a last segment, and the UDP body including a data payload of predetermined size;
   grouping the plurality of UDP segments into at least one window, for transmission through the selectable communication medium, wherein the at least one window includes a predetermined number of UDP segments from the plurality of UDP segments; and
   sending the at least one window to the server;
at the server, receiving the data through the selectable communication medium from the remote electronic device, the receiving comprising:
   receiving at least one UDP segment;
   assembling UDP segments to recreate the TXU packet;
   upon determination that the segment number of the UDP segment indicates a window first segment prior to a final window first segment for the TXU packet, sending an ACK to the remote electronic device;
   upon determination that at least one UDP segment was not received, sending a NAK message to the remote electronic device, the NAK message specifying the segment number for each missing segment; and
   upon determination that a final UDP segment for the TXU packet has been received, sending an ACK message to the remote electronic device;
at the remote electronic device, upon receiving the ACK message from the server, if a next window from the at least one window remains to be sent, sending the next window from the remote electronic device to the server;
at the remote electronic device, upon receipt of the NAK message:
retransmitting missing UDP segments to the server, the retransmitting comprising:
   identifying a plurality of missing UDP segments according to the NAK message;
   grouping the plurality of missing UDP segments into a retransmit window, the retransmit window having a number of UDP segments corresponding to a count of missing UDP segments; and
   sending the retransmit window to the server; and
at the server, upon determination that a final TXU packet for the frame has been received, recreating the frame by reassembling the plurality of TXU packets.

2. The method of claim 1, wherein the selectable communication medium is a wireless network.

3. The method of claim 2, wherein the selectable communication medium includes one or more of a Wi-Fi network, a GPRS (General Packet Radio Service) network, a CDMA (Code Division Multiple Access) network, a GSM (Global System for Mobile communications) network, and a satellite network.

4. The method of claim 3, further comprising the step of:
switching to a different selectable communication media during transmission of the data.

5. The method of claim 3, further comprising the step of:
switching to a different selectable communication media during reception of the data.

6. The method of claim 1, wherein the predetermined number of UDP segments for the at least one window is an optimized value corresponding to the selectable communication medium.

7. The method of claim 1, wherein the packet length is a predetermined value corresponding to the selectable communication medium.

8. The method of claim 1, wherein a UDP segment length indicates a UDP segment size for the UDP segment, the UDP segment size corresponding to the selectable communication medium.

9. The method of claim 1, wherein a window length is equal to the predetermined number of UDP segments, the window length having a value corresponding to the selectable communication medium.

10. The method of claim 1, wherein the agent type is a one byte field indicating a value selectable from: realtime, batch, and auto.

11. The method of claim 1, wherein the agent name is a 40 byte field and contains a name of an object, wherein the object includes the data and executable code.

12. The method of claim 1, wherein the data length is a 4 byte field indicating the size in bytes of the data buffer.

13. The method of claim 1, wherein the data buffer is a variable size buffer containing the data to be transmitted.

14. The method of claim 1, wherein the packet type is a one byte field indicating a value for the packet type.

15. The method of claim 1, wherein the session ID is a 4 byte field identifying a destination entity.

16. The method of claim 15, wherein the pipe number is a 4 byte field identifying a connection to the destination entity.

17. The method of claim 1, wherein the packet length is a 2 byte field indicating the size in bytes of the packet data.

18. The method of claim 1, wherein the UDP type is a one byte field indicating a value selectable from: UDP Segment, UDP ACK, UDP NAK, and UDP Probe.

19. The method of claim 1, wherein the packet ID is a two byte field identifying the TXU packet to which the UDP segment is designated.

20. The method of claim 1, wherein the segment number is a one byte field indicating a sequential ordering of the UDP segment within the TXU packet.

21. The method of claim 1, wherein the last segment is a one byte field indicating the segment number corresponding to the final UDP segment in the TXU packet.

22. The method of claim 1, wherein the UDP body comprises UDP segment data to be transmitted.

23. The method of claim 1, further comprising the step of:
at the remote electronic device, waiting a predetermined probe time, without receiving the ACK or a NAK, before sending a probe message to the server.

24. The method of claim 23, wherein the probe message is a type of the UDP segment.

25. The method of claim 24, wherein the probe message includes the segment number of a recent UDP segment for which the ACK was received.

26. The method of claim 23, wherein a predetermined probe retry count denotes the count of probe messages to send to the server, without receiving the ACK or the NAK, before reporting an error.

27. The method of claim 1, further comprising the step of:
at the server, upon sending a NAK to the remote electronic device, waiting a predetermined probe time, without receiving the UDP segment, before sending a probe message to the remote electronic device.

28. The method of claim 27, wherein the probe message is a type of the UDP segment.

29. The method of claim 28, wherein the probe message includes the segment number for the UDP segment most recently received.

30. The method of claim 28, wherein a predetermined probe retry count denotes the count of probe messages to send to the remote electronic device, without receiving the UDP segment, before reporting an error.

31. A method for wireless data communication between a first computing device and a second computing device, comprising steps of:
at the first computing device,
transmitting data through a selectable wireless communication medium to the second computing device the transmitting comprising:
   constructing a frame for data, the frame comprising a frame header and a frame body, the frame header including an agent type, an agent name, and a data length, and the frame body including a data buffer corresponding to the data length;
   dividing the frame into a plurality of TXU packets that collectively comprise the frame body, wherein a TXU packet from the plurality of TXU packets comprises a packet header and a packet body, the packet header including a packet type, a session ID, a pipe number, and a packet length, and the packet body including packet data corresponding to the packet length;
   dividing the TXU packet into a plurality of UDP segments, wherein a UDP segment from the plurality of UDP segments comprises a UDP header and a UDP body, the UDP header including a UDP type, a packet ID, a segment number, a last segment, and the UDP body including a data payload of predetermined size;
   grouping the plurality of UDP segments into at least one window, for transmission through the selectable wireless communication medium, wherein the at least one window includes a predetermined number of UDP segments; and
   sending the at least one window to the second computing device;
at the second computing device, receiving the data through the selectable wireless communication medium from the first computing device, the receiving comprising:
   receiving at least one UDP segment;
   assembling UDP segments to recreate the TXU packet;
   upon determination that a final UDP segment for the TXU packet has been received, sending an ACK message to the first computing device;
   upon determination that at least one UDP segment was not received, sending a NAK message to the first computing device, the NAK message specifying the segment number for each missing segment;
at the first computing device, upon receiving the ACK message, if a next window from the at least one window remains to be sent, sending the next window from the first computing device to the second computing device;
at the first computing device, upon receipt of the NAK message,
retransmitting missing UDP segments to the second computing device, the retransmitting comprising:
   identifying a plurality of missing UDP segments according to the NAK message;
   grouping the plurality of missing UDP segments into a retransmit window, the retransmit window having a number of UDP segments corresponding to a count of missing UDP segments; and
   sending the retransmit window to the second computing device; and
at the second computing device, upon determination that a final TXU packet for the frame has been received, recreating the frame by reassembling the plurality of TXU packets.

32. The method of claim 31, wherein the selectable wireless communication medium includes one or more of a Wi-Fi network, a GPRS (General Packet Radio Service) network, a CDMA (Code Division Multiple Access) network, a GSM (Global System for Mobile communications) network, and a satellite network.

33. The method of claim 31, further comprising the step of:
switching to a different selectable communication media during transmission of the data.

34. The method of claim 31, wherein the predetermined number of UDP segments for the at least one window is an optimized value corresponding to the selectable wireless communication medium.

35. The method of claim 31, wherein the packet length is a predetermined value corresponding to the selectable wireless communication medium.

36. The method of claim 31, wherein a UDP segment length indicates a UDP segment size for the UDP segment, the UDP segment size corresponding to the selectable wireless communication medium.

37. The method of claim 31, wherein a window length equals the predetermined number of UDP segments, the window length having a value corresponding to the selectable wireless communication medium.

38. The method of claim 31, wherein the agent type is a field indicating a value selectable from: realtime, batch, and auto.

39. The method of claim 31, wherein the agent name contains a name of an object, wherein the object includes the data and executable code.

40. The method of claim 31, wherein the data length indicates the size in bytes of the data buffer.

41. The method of claim 31, wherein the data buffer is a variable size buffer containing the data to be transmitted.

42. The method of claim 31, wherein the packet type indicates a value for the packet type.

43. The method of claim 31, wherein the session ID identifies a destination entity.

44. The method of claim 43, wherein the pipe number identifies a connection to the destination entity.

45. The method of claim 31, wherein the packet length indicates the size in bytes of the packet data.

46. The method of claim 31, wherein the UDP type is a field indicating a value selectable from: UDP Segment, UDP ACK, UDP NAK, and UDP Probe.

47. The method of claim 31, wherein the packet ID is a field identifying the TXU packet to which the UDP segment is designated.

48. The method of claim 31, wherein the segment number is a field indicating a sequential ordering of the UDP segment within the TXU packet.

49. The method of claim 31, wherein the last segment is a field indicating the segment number corresponding to a final segment in the TXU packet.

50. The method of claim 31, wherein the UDP body comprises UDP segment data to be transmitted.

51. The method of claim 31, further comprising the step of:
at the first computing device, waiting a predetermined probe time, without receiving an ACK or a NAK, prior to sending at least one UDP segment probe message to the second computing device.

52. The method of claim 51, wherein the at least one UDP segment probe message includes the segment number of a recent UDP segment for which the ACK was received.

53. The method of claim 51, wherein a predetermined probe retry count denotes the number of the at least one UDP segment probe message to send to the second computing device, without receiving the ACK or the NAK, before reporting an error.

54. The method of claim 31, further comprising the step of:
at the second computing device, upon sending a NAK to the first computing device, waiting a predetermined probe time, without receiving the UDP segment, prior to sending at least one UDP segment probe message to the first computing device.

55. The method of claim 54, wherein the at least one UDP segment probe message includes the segment number for the UDP segment most recently received.

56. The method of claim 54, wherein a predetermined probe retry count denotes a number of the at least one UDP segment probe message to send to the first computing device, without receiving the UDP segment, before reporting an error.

57. A method for data communication between a first computing device and a second computing device, comprising steps of:
at the first computing device,
transmitting data through a selectable communication medium to the second computing device the transmitting comprising:
   constructing a frame for the data;
   dividing the frame into a plurality of TXU packets;
   dividing each TXU packet into a plurality of UDP segments;
   grouping the plurality of UDP segments into at least one window, wherein the at least one window includes a predetermined number of UDP segments from the plurality of UDP segments; and
   sending the at least one window to the second computing device;
at the second computing device, receiving the data through the selectable communication medium from the first computing device, the receiving comprising:
   receiving a UDP segment from the plurality of UDP segments;
   assembling the plurality of UDP segments to recreate a TXU packet;
   upon determination that a last UDP segment, from the plurality of UDP segments, for the TXU packet that has been received, sending an ACK message to the first computing device; and
   upon determination that at least one UDP segment, from the plurality of UDP segments, was not received, sending a NAK message, that specifies each missing segment, to the first computing device;
at the first computing device, upon receiving the ACK message, if a next window from the at least one window remains to be sent, sending the next window from the first computing device to the second computing device;
at the first computing device, upon receiving a NAK message, retransmitting at least one missing UDP segment, from the plurality of UDP segments to the second computing device; and
at the second computing device, upon determination that a final TXU packet for the frame has been received, recreating the frame by reassembling the plurality of TXU packets.

58. The method of claim 57, wherein the selectable communication medium is a wireless network.

59. The method of claim 58, wherein the selectable communication medium includes one or more of a Wi-Fi network, a GPRS (General Packet Radio Service) network, a CDMA (Code Division Multiple Access) network, a GSM (Global System for Mobile communications) network, and a satellite network.

60. The method of claim 59, further comprising the step of:
switching to a different selectable communication media, during transmission of the data.

61. The method of claim 59, further comprising the step of:
switching to a different selectable communication media during reception of the data.

62. The method of claim 57, wherein the predetermined number of UDP segments for the at least one window is an optimized value corresponding to the selectable communication medium.

63. The method of claim 57, wherein a UDP segment length indicates a UDP segment size for the UDP segment, the UDP segment size having a value corresponding to the selectable communication medium.

64. The method of claim 57, wherein a window length equals the predetermined number of UDP segments, the window length having a value corresponding to the selectable communication medium.

65. The method of claim 57, wherein the frame comprises a frame header and a frame body, the frame header including an agent type, an agent name, and a data length, and the frame body including a data buffer corresponding to the data length.

66. The method of claim 65, wherein the agent type indicates a value selectable from: realtime, batch, and auto.

67. The method of claim 65, wherein the agent name contains a name of an object that includes the data and executable code.

68. The method of claim 65, wherein the data length indicates a size in bytes of the data buffer.

69. The method of claim 65, wherein the data buffer is a variable size buffer containing the data to be transmitted.

70. The method of claim 57, wherein each TXU packet comprises a packet header and a packet body, the packet header including a packet type, a session ID, a pipe number, and a packet length, and the packet body including packet data corresponding to the packet length.

71. The method of claim 70, wherein the packet type indicates a value for the packet type.

72. The method of claim 70, wherein the session ID identifies a destination entity.

73. The method of claim 72, wherein the pipe number identifies a connection to the destination entity.

74. The method of claim 70, wherein the packet length indicates a size in bytes of the packet data.

75. The method of claim 70, wherein the packet length is a predetermined value corresponding to the selectable communication medium.

76. The method of claim 57, wherein a UDP from the at least one UDP segment comprises a UDP header and a UDP body, the UDP header including a UDP type, a packet ID, a segment number, a last segment, and the UDP body including a data payload of predetermined size.

77. The method of claim 76, wherein the UDP type indicates a value selectable from: UDP Segment, UDP ACK, UDP NAK, and UDP Probe.

78. The method of claim 76, wherein the packet ID identifies the TXU packet to which the UDP segment is designated.

79. The method of claim 76, wherein the segment number indicates a sequential ordering of the UDP segment within the TXU packet.

80. The method of claim 76, wherein the last segment indicates the segment number corresponding to a final segment in the TXU packet.

81. The method of claim 57, further comprising the step of:
at the first computing device, waiting a predetermined probe time without receiving an ACK or a NAK, prior to sending at least one probe message to the second computing device.

82. The method of claim 81, wherein the at least one probe message includes a segment number of a recent UDP segment for which the ACK was received.

83. The method of claim 81, wherein a predetermined probe retry count denotes a count of the at least one probe message to send to the second computing device, without receiving the ACK or the NAK, before reporting an error.

84. The method of claim 57, further comprising the step of:
at the second computing device, upon sending a NAK to the first computing device, waiting a predetermined probe time without receiving the UDP segment, prior to sending at least one probe message to the first computing device.

85. The method of claim 84, wherein the at least one probe message includes a segment number for the UDP segment most recently received.

86. The method of claim 84, wherein a predetermined probe retry count denotes a count of the at least one probe message to send to the first computing device, without receiving the UDP segment, before reporting an error.

87. A system for data communication between multiple computing devices, the system comprising:
a first computing device configured for communication through a selectable communication medium with a second computing device, the first computing device comprising:
   a first TXM module operable for:
      receiving the data from a first application;
      constructing a frame for the data;
      dividing the frame into a plurality of TXU packets that collectively comprise a frame body;
      sending a TXU packet from the plurality of TXU packets to a first TXU module; and
      upon receiving notification that the TXU packet has been sent successfully, if a next TXU packet from the plurality of TXU packets remains to be sent, sending the next TXU packet to the first TXU module;
   the first TXU module operable for:
      receiving the TXU packet from the first TXM module;
      dividing the TXU packet into a plurality of UDP segments;
      grouping the plurality of UDP segments into at least one window, wherein the at least one window includes a predetermined number of UDP segments from the plurality of UDP segments; and
      sending the at least one window through the selectable communication medium to a second TXU module at the second computing device;
      upon receipt of an ACK message, if a next window remains, sending the next window to the second TXU module; and
      upon the receipt of a NAK message, wherein the NAK message specifies at least one missing UDP segment, retransmitting the at least one missing UDP segment to the second TXU module;
the second computing device configured for communication through the selectable communication medium with the first computing device, the second computing device comprising:
   the second TXU module operable for:
      receiving a UDP segment of the at least one window, through the selectable communication medium from the first TXU module;
      assembling the UDP segment to recreate the TXU packet;
      upon determination that at least one different UDP segment was not received, sending the NAK message through the selectable communication medium to the first TXU module, the NAK message specifying the at least one missing UDP segment that corresponds to the at least one different UDP segment; and
      upon determination that a final UDP segment for the TXU packet has been received:
         sending the ACK message to the first TXU module;
         sending the TXU packet to a second TXM module;
   the second TXM module operable for:
      receiving the TXU packet from the second TXU module;
      upon determination that the TXU packet is a first TXU packet for a new frame, creating the new frame;
      upon determination that a final TXU packet for the new frame has been received, recreating the new frame by reassembling the plurality of TXU packets that include the data; and
      providing the data from the new frame to a second application.

88. The system of claim 87, wherein the selectable communication medium is a wireless network.

89. The system of claim 88, wherein the selectable communication medium includes one or more of a Wi-Fi network, a GPRS (General Packet Radio Service) network, a CDMA (Code Division Multiple Access) network, a GSM (Global System for Mobile communications) network, and a satellite network.

90. The system of claim 87, wherein the frame comprises a frame header and the frame body, the frame header including an agent type, an agent name, and a data length, and the frame body including a data buffer corresponding to the data length.

91. The system of claim 90, wherein the agent type indicates a value selectable from: real time, batch, and auto.

92. The system of claim 90, wherein the agent name contains a name of an object that includes agent data and executable code.

93. The system of claim 90, wherein the data length indicates a size for the data buffer.

94. The system of claim 90, wherein the data buffer is a variable size buffer containing the data to be transmitted.

95. The system of claim 87, wherein the TXU packet comprises a packet header and a packet body, the packet header including a packet type, a session ID, a pipe number, and a packet length, and the packet body including packet data corresponding to the packet length.

96. The system of claim 95, wherein the packet type indicates a value for the packet type.

97. The system of claim 95, wherein the session ID identifies a destination entity.

98. The system of claim 97, wherein the pipe number identifies a connection to the destination entity.

99. The system of claim 95, wherein the packet length indicates a size for the packet data.

100. The system of claim 87, wherein the UDP segment comprises a UDP header and a UDP body, the UDP header including a UDP type, a packet ID, a segment number, a last segment, and the UDP body including a data payload of predetermined size.

101. The system of claim 100, wherein the UDP type indicates a value selectable from: UDP Segment, UDP ACK, UDP NAK, and UDP Probe.

102. The system of claim 100, wherein the packet ID identifies the TXU packet to which the UDP segment is designated.

103. The system of claim 100, wherein the segment number indicates a sequential ordering of the UDP segment within the TXU packet.

104. The system of claim 100, wherein the last segment indicates the segment number corresponding to the final UDP segment in the TXU packet.

105. The system of claim 87, wherein the first TXU module is further configured for waiting a predetermined probe time, without receiving an ACK or a NAK, before sending a probe message to the second TXU module.

106. The system of claim 105, wherein the probe message is a type of the UDP segment.

107. The system of claim 106, wherein the probe message includes a segment number of a recent UDP segment for which the ACK was received.

108. The system of claim 105, wherein a predetermined probe retry count denotes a count of probe messages to send to the second TXU module, without receiving the ACK or the NAK, before reporting an error.

109. The system of claim 87, wherein the first computing device is further configured for:
upon sending a NAK to the second computing device, waiting a predetermined probe time, without receiving the UDP segment, before sending a probe message to the second computing device.

110. The system of claim 109, wherein the probe message is a type of the UDP segment.

111. The system of claim 110, wherein the probe message includes a segment number for the UDP segment recently received.

112. The system of claim 109, wherein a predetermined probe retry count denotes a count of probe messages to send to the first TXU module, without receiving the UDP segment, before reporting an error.

Aspect 2 (Transmission): Methods and Systems for transmitting data from multiple computing devices to multiple computing devices.

113. A method for data communication between a remote electronic device and a server, comprising steps of:
transmitting data from the remote electronic device through a selectable communication medium to the server, the transmitting comprising:
   constructing a frame for data, the frame comprising a frame header and a frame body, the frame header including an agent type, an agent name, and a data length, and the frame body including a data buffer corresponding to the data length;
   dividing the frame into a plurality of TXU packets that collectively comprise the frame body, wherein a TXU packet from the plurality of TXU packets comprises a packet header and a packet body, the packet header including a packet type, a session ID, a pipe number, and a packet length, and the packet body including packet data corresponding to the packet length;
   dividing the TXU packet into a plurality of UDP segments, wherein a UDP segment from the plurality of UDP segments comprises a UDP header and a UDP body, the UDP header including a UDP type, a packet ID, a segment number, a last segment, and the UDP body including a data payload of predetermined size;
   grouping the plurality of UDP segments into at least one window, for transmission through the selectable communication medium, wherein the at least one window includes a predetermined number of UDP segments from the plurality of UDP segments; and
   sending the at least one window to the server;
upon receiving an ACK message from the server, if a next window from the at least one window remains to be sent, sending the next window from the remote electronic device to the server;
upon receipt of a NAK message:
retransmitting missing UDP segments from the remote electronic device to the server, the retransmitting comprising:
   identifying a plurality of missing UDP segments according to the NAK message;
   grouping the plurality of missing UDP segments into a retransmit window, the retransmit window having a number of UDP segments corresponding to a count of missing UDP segments; and
   sending the retransmit window to the server.

114. The method of claim 113, wherein the selectable communication medium is a wireless network.

115. The method of claim 114, wherein the selectable communication medium includes one or more of a Wi-Fi network, a GPRS (General Packet Radio Service) network, a CDMA (Code Division Multiple Access) network, a GSM (Global System for Mobile communications) network, and a satellite network.

116. The method of claim 115, further comprising the step of:
switching to a different selectable communication media during transmission of the data.

117. The method of claim 113, wherein the predetermined number of UDP segments for the at least one window is an optimized value corresponding to the selectable communication medium.

118. The method of claim 113, wherein the packet length is a predetermined value corresponding to the selectable communication medium.

119. The method of claim 113, wherein a UDP segment length indicates the size of the UDP segment, the UDP segment length having a value corresponding to the selectable communication medium.

120. The method of claim 113, wherein a window length equals the predetermined number of UDP segments, the window length having a value corresponding to the selectable communication medium.

121. The method of claim 113, wherein the agent type is a one byte field indicating a value selectable from: realtime, batch, and auto.

122. The method of claim 113, wherein the agent name is a 40 byte field and contains a name of an object, wherein the object includes the data and executable code.

123. The method of claim 113, wherein the data length is a 4 byte field indicating the size in bytes of the data buffer.

124. The method of claim 113, wherein the data buffer is a variable size buffer containing the data to be transmitted.

125. The method of claim 113, wherein the packet type is a one byte field indicating a value for the packet type.

126. The method of claim 113, wherein the session ID is a 4 byte field identifying a destination entity.

127. The method of claim 126, wherein the pipe number is a 4 byte field identifying a connection to the destination entity.

128. The method of claim 113, wherein the packet length is a 2 byte field indicating the size in bytes of the packet data.

129. The method of claim 113, wherein the UDP type is a one byte field indicating a value selectable from: UDP Segment, UDP ACK, UDP NAK, and UDP Probe.

130. The method of claim 113, wherein the packet ID is a two byte field identifying the TXU packet to which the UDP segment is designated.

131. The method of claim 113, wherein the segment number is a one byte field indicating a sequential ordering of the UDP segment within the TXU packet.

132. The method of claim 113, wherein the last segment is a one byte field indicating the segment number corresponding to a final segment in the TXU packet.

133. The method of claim 113, wherein the UDP body comprises UDP segment data to be transmitted.

134. The method of claim 113, further comprising the step of:
at the remote electronic device waiting a predetermined probe time without receiving an ACK or a NAK before sending a probe message to the server.

135. The method of claim 134, wherein the probe message is a type of the UDP segment.

136. The method of claim 135, wherein the probe message includes the segment number of a recent UDP segment for which the ACK was received.

137. The method of claim 134, wherein a predetermined probe retry count denotes a number of probe messages to send to the server without receiving the ACK or the NAK before reporting an error.

138. A method for wireless data communication between a first computing device and a second computing device, comprising steps of:
transmitting data from the first computing device through a selectable wireless communication medium to the second computing device, the transmitting comprising:
   constructing a frame for data, the frame comprising a frame header and a frame body, the frame header including an agent type, an agent name, and a data length, and the frame body including a data buffer corresponding to the data length;
   dividing the frame into a plurality of TXU packets that collectively comprise the frame body, wherein a TXU packet from the plurality of TXU packets comprises a packet header and a packet body, the packet header including a packet type, a session ID, a pipe number, and a packet length, and the packet body including packet data corresponding to the packet length;
   dividing the TXU packet into a plurality of UDP segments, wherein a UDP segment from the plurality of UDP segments comprises a UDP header and a UDP body, the UDP header including a UDP type, a packet ID, a segment number, a last segment, and the UDP body including a data payload of predetermined size;
   grouping the plurality of UDP segments into at least one window, for transmission through the selectable wireless communication medium, wherein the at least one window includes a predetermined number of UDP segments; and
   sending the at least one window to the second computing device;
upon receiving an ACK message from the second computing device, if a next window from the at least one window remains to be sent, sending the next window from the first computing device to the second computing device;
upon receipt of a NAK message specifying missing UDP segments,
retransmitting missing UDP segments from the first computing device to the second computing device, the retransmitting comprising:
   identifying a plurality of missing UDP segments according to a NAK message;
   grouping the plurality of missing UDP segments into a retransmit window, the retransmit window having a number of UDP segments corresponding to a count of missing UDP segments; and
   sending the retransmit window to the second computing device.

139. The method of claim 138, wherein the selectable wireless communication medium includes one or more of a Wi-Fi network, a GPRS (General Packet Radio Service) network, a CDMA (Code Division Multiple Access) network, a GSM (Global System for Mobile communications) network, and a satellite network.

140. The method of claim 138, further comprising the step of:
switching to a different selectable communication media during transmission of the data.

141. The method of claim 138, wherein the predetermined number of UDP segments for the at least one window is an optimized value corresponding to the selectable wireless communication medium.

142. The method of claim 138, wherein the packet length is a predetermined value corresponding to the selectable wireless communication medium.

143. The method of claim 138, wherein a UDP segment length indicates a UDP segment size for the UDP segment, the UDP segment size corresponding to the selectable wireless communication medium.

144. The method of claim 138, wherein a window length equals the predetermined number of UDP segments, the window length having a value corresponding to the selectable wireless communication medium.

145. The method of claim 138, wherein the agent type is a field indicating a value selectable from: realtime, batch, and auto.

146. The method of claim 138, wherein the agent name is contains a name of an object, wherein the object includes the data and executable code.

147. The method of claim 138, wherein the data length is a 4 byte field indicating the size in bytes of the data buffer.

148. The method of claim 138, wherein the data buffer is a variable size buffer containing the data to be transmitted.

149. The method of claim 138, wherein the packet type indicates a value for the packet type.

150. The method of claim 138, wherein the session ID identifies a destination entity.

151. The method of claim 150, wherein the pipe number identifies a connection to the destination entity.

152. The method of claim 138, wherein the packet length indicates the size in bytes of the packet data.

153. The method of claim 138, wherein the UDP type is a field indicating a value selectable from: UDP Segment, UDP ACK, UDP NAK, and UDP Probe.

154. The method of claim 138, wherein the packet ID is a field identifying the TXU packet to which the UDP segment is designated.

155. The method of claim 138, wherein the segment number is a field indicating a sequential ordering of the UDP segment within the TXU packet.

156. The method of claim 138, wherein the last segment is a field indicating the segment number corresponding to a final segment in the TXU packet.

157. The method of claim 138, wherein the UDP body comprises UDP segment data to be transmitted.

158. The method of claim 138, further comprising the step of:
at the first computing device, waiting a predetermined probe time, without receiving an ACK or a NAK, prior to sending at least one UDP segment probe message to the second computing device.

159. The method of claim 158, wherein the at least one UDP segment probe message includes the segment number of a recent UDP segment for which the ACK was received.

160. The method of claim 158, wherein a predetermined probe retry count denotes the number of the at least one UDP segment probe message to send to the second computing device, without receiving the ACK or the NAK, before reporting an error.

161. A method for data communication between a first computing device and a second computing device, comprising steps of:
at the first computing device,
transmitting data through a selectable communication medium to the second computing device the transmitting comprising:
   constructing a frame for the data;
   dividing the frame into a plurality of TXU packets;
   dividing the plurality of TXU packets into a plurality of UDP segments;
   grouping the plurality of UDP segments into at least one window, wherein the at least one window includes a predetermined number of UDP segments from the plurality of UDP segments; and
   sending the at least one window to the second computing device;
   upon receiving a NAK message, retransmitting at least one missing UDP segment to the second computing device; and
   upon receiving an ACK message, if a next window from the at least one window remains to be sent, sending the next window from the first computing device to the second computing device.

162. The method of claim 161, wherein the selectable communication medium is a wireless network.

163. The method of claim 162, wherein the selectable communication medium includes one or more of a Wi-Fi network, a GPRS (General Packet Radio Service) network, a CDMA (Code Division Multiple Access) network, a GSM (Global System for Mobile communications) network, and a satellite network.

164. The method of claim 163, further comprising the step of:
switching to a different selectable communication media, during transmission of the data.

165. The method of claim 161, wherein the predetermined number of UDP segments for the at least one window is an optimized value corresponding to the selectable communication medium.

166. The method of claim 161, wherein a UDP segment length indicates a UDP segment size for a UDP segment from the plurality of UDP segments, the UDP segment size having a value corresponding to the selectable communication medium.

167. The method of claim 161, wherein a window length equals the predetermined number of UDP segments, the window length having a value corresponding to the selectable communication medium.

168. The method of claim 161, wherein the frame comprises a frame header and a frame body, the frame header including an agent type, an agent name, and a data length, and the frame body including a data buffer corresponding to the data length.

169. The method of claim 168, wherein the agent type is a one byte field indicating a value selectable from: real time, batch, and auto.

170. The method of claim 168, wherein the agent name is a 40 byte field and contains a name of an object, wherein the object includes the data and executable code.

171. The method of claim 168, wherein the data length is a 4 byte field indicating a size in bytes of the data buffer.

172. The method of claim 168, wherein the data buffer is a variable size buffer containing the data to be transmitted.

173. The method of claim 161, wherein a TXU packet, from the plurality of TXU packets, comprises a packet header and a packet body, the packet header including a packet type, a session ID, a pipe number, and a packet length, and the packet body including packet data corresponding to the packet length.

174. The method of claim 173, wherein the packet type is a one byte field indicating a value for the packet type.

175. The method of claim 173, wherein the session ID is a 4 byte field identifying a destination entity.

176. The method of claim 175, wherein the pipe number is a 4 byte field identifying a connection to the destination entity.

177. The method of claim 173, wherein the packet length is a 2 byte field indicating a size in bytes of the packet data.

178. The method of claim 173, wherein the packet length is a predetermined value corresponding to the selectable communication medium.

179. The method of claim 161, wherein a UDP segment from the plurality of UDP segments comprises a UDP header and a UDP body, the UDP header including a UDP type, a packet ID, a segment number, a last segment, and the UDP body including a data payload of predetermined size.

180. The method of claim 179, wherein the UDP type indicates a value selectable from: UDP Segment, UDP ACK, UDP NAK, and UDP Probe.

181. The method of claim 179, wherein the packet ID identifies a TXU packet, from the plurality of TXU packets, to which the UDP segment is designated.

182. The method of claim 181, wherein the segment number indicates a sequential ordering of the UDP segment within the TXU packet.

183. The method of claim 181, wherein the last segment indicates the segment number corresponding to a final segment in the TXU packet.

184. The method of claim 161, further comprising the step of:
at the first computing device, waiting a predetermined probe time without receiving an ACK or a NAK, prior to sending at least one probe message to the second computing device.

185. The method of claim 184, wherein the at least one probe message includes a segment number of a recent UDP segment for which the ACK was received.

186. The method of claim 184, wherein a predetermined probe retry count denotes a count of the at least one probe message to send to the second computing device, without receiving the ACK or the NAK, before reporting an error.

Aspect 3 (Receive): Methods and Systems for receiving data at multiple computing devices from multiple computing devices.

187. A method for receiving data from a remote electronic device through a selectable communication medium, comprising steps of:
receiving a plurality of UDP segments, wherein a UDP segment from the plurality of UDP segments comprises a UDP header and a UDP body, the UDP header including a UDP type, a packet ID, a segment number, a last segment, and the UDP body including a data payload of predetermined size;
upon determination that the segment number indicates a first UDP segment, creating a TXU packet, the TXU packet comprising a packet header, and a packet body, the packet header including a packet type, a session ID, a pipe number, and a packet length, and the packet body including packet data corresponding to the packet length;
upon determination that the segment number indicates the UDP segment sequentially after the first UDP segment, adding the UDP segment to the TXU packet;
upon determination that the segment number indicates an initial segment in a window prior to a final window initial segment for the TXU packet, sending an ACK to the remote electronic device;
upon determination that the UDP segment was not received, sending a NAK message to the remote electronic device, the NAK message specifying the segment number for each missing segment;
upon determination that the segment number indicates the last segment, verifying that all UDP segments have been received;
upon determination that all UDP segments have been received, sending an ACK message to the remote electronic device;
upon determination that a final TXU packet has been received, recreating a frame by reassembling a plurality of TXU packets, the frame comprising a frame header and a frame body, the frame header including an agent type, an agent name, and a data length, and the frame body including a data buffer for data and corresponding to the data length.

188. The method of claim 187, wherein the selectable communication medium is a wireless network.

189. The method of claim 188, wherein the selectable communication medium includes one or more of a Wi-Fi network, a GPRS (General Packet Radio Service) network, a CDMA (Code Division Multiple Access) network, a GSM (Global System for Mobile communications) network, and a satellite network.

190. The method of claim 189, further comprising the step of:
switching to a different selectable communication media during reception of the data.

191. The method of claim 187, wherein the agent type is a one byte field indicating a value selectable from: real time, batch, and auto.

192. The method of claim 187, wherein the agent name is a 40 byte field and contains a name of an object, wherein the object includes the data and executable code.

193. The method of claim 187, wherein the data length is a 4 byte field indicating the size in bytes of the data buffer.

194. The method of claim 187, wherein the data buffer is a variable size buffer containing the data to be transmitted.

195. The method of claim 187, wherein the packet type is a one byte field indicating a value for the packet type.

196. The method of claim 187, wherein the session ID is a 4 byte field identifying a destination.

197. The method of claim 196, wherein the pipe number is a 4 byte field identifying a connection to the destination.

198. The method of claim 187, wherein the packet length is a 2 byte field indicating the size in bytes of the packet data.

199. The method of claim 187, wherein the UDP type is a one byte field indicating a value selectable from: UDP Segment, UDP ACK, UDP NAK, and UDP Probe.

200. The method of claim 187, wherein the packet ID is a two byte field identifying the TXU packet to which the UDP segment is designated.

201. The method of claim 187, wherein the segment number is a one byte field indicating a sequential ordering of the UDP segment within the TXU packet.

202. The method of claim 187, wherein the last segment is a one byte field indicating the segment number corresponding to a final segment in the TXU packet.

203. The method of claim 187, wherein the UDP body comprises UDP segment data to be transmitted.

204. The method of claim 187, further comprising the step of:
upon sending a NAK to the remote electronic device, waiting a predetermined probe time without receiving the UDP segment before sending a probe message to the remote electronic device.

205. The method of claim 204, wherein the probe message is a type of the UDP segment.

206. The method of claim 205, wherein the probe message includes the segment number for the UDP segment most recently received.

207. The method of claim 204, wherein a predetermined probe retry count denotes a count of probe messages to send to the remote electronic device, without receiving the UDP segment before reporting an error.

208. A method for receiving data from a first computing device through a wireless communication medium, comprising steps of:
receiving a plurality of UDP segments, wherein a UDP segment from the plurality of UDP segments comprises a UDP header and a UDP body, the UDP header including a UDP type, a packet ID, a segment number, a last segment, and the UDP body including a data payload of predetermined size;
upon determination that the segment number indicates a first UDP segment, creating a TXU packet, the TXU packet comprising a packet header, and a packet body, the packet header including a packet type, a session ID, a pipe number, and a packet length, and the packet body including packet data corresponding to the packet length;
upon determination that the segment number indicates the UDP segment sequentially after the first UDP segment, adding the UDP segment to the TXU packet;
upon determination that the segment number indicates an initial segment in a window prior to a final window initial segment for the TXU packet, sending an ACK to the first computing device;
upon determination that the UDP segment was not received, sending a NAK message to the first computing device, the NAK message specifying the segment number for each missing segment;
upon determination that the segment number indicates the last segment, verifying that all UDP segments have been received;
upon determination that all UDP segments have been received, sending an ACK message to the first computing device;
upon determination that a final TXU packet has been received, recreating a frame by reassembling a plurality of TXU packets, the frame comprising a frame header and a frame body, the frame header including an agent type, an agent name, and a data length, and the frame body including a data buffer corresponding to the data length.

209. The method of claim 208, wherein the wireless communication medium is a selectable communication medium that includes one or more of a Wi-Fi network, a GPRS (General Packet Radio Service) network, a CDMA (Code Division Multiple Access) network, a GSM (Global System for Mobile communications) network, and a satellite network.

210. The method of claim 208, further comprising the step of:
switching to a different selectable wireless communication media during reception of data.

211. The method of claim 208, wherein the agent type is a field indicating a value selectable from: real time, batch, and auto.

212. The method of claim 208, wherein the agent name contains a name of an object, wherein the object includes data and executable code.

213. The method of claim 208, wherein the data length indicates the size in bytes of the data buffer.

214. The method of claim 208, wherein the data buffer is a variable size buffer containing data to be transmitted.

215. The method of claim 208, wherein the packet type indicates a value for the packet type.

216. The method of claim 208, wherein the session ID identifies a destination.

217. The method of claim 216, wherein the pipe number identifies a connection to the destination.

218. The method of claim 208, wherein the packet length indicates the size in bytes of the packet data.

219. The method of claim 208, wherein the UDP type is a field indicating a value selectable from: UDP Segment, UDP ACK, UDP NAK, and UDP Probe.

220. The method of claim 208, wherein the packet ID is a field identifying the TXU packet to which the UDP segment is designated.

221. The method of claim 208, wherein the segment number is a field indicating a sequential ordering of the UDP segment within the TXU packet.

222. The method of claim 208, wherein the last segment is a field indicating the segment number corresponding to a final segment in the TXU packet.

223. The method of claim 208, wherein the UDP body comprises UDP segment data to be transmitted.

224. The method of claim 208, further comprising the step of:
upon sending a NAK to the first computing device, waiting a predetermined probe time without receiving the UDP segment, prior to sending at least one UDP segment probe message to the first computing device.

225. The method of claim 224, wherein the at least one UDP segment probe message includes the segment number for the UDP segment most recently received.

226. The method of claim 224, wherein a predetermined probe retry count denotes a number of the at least one UDP segment probe message to send to the first computing device, without receiving the UDP segment, before reporting an error.

227. A method for receiving data from a first computing device, comprising steps of:
receiving data through a selectable communication medium from the first computing device, the receiving comprising:
   receiving a plurality of UDP segments;
   assembling the plurality of UDP segments to recreate a TXU packet;
   upon determination that a last UDP segment for the TXU packet has been received, sending an ACK message to the first computing device; and
   upon determination that at least one UDP segment was not received, sending a NAK message, that specifies at least one missing UDP segment, to the first computing device;
   upon determination that a final TXU packet for a frame has been received, recreating the frame by reassembling a plurality of TXU packets.

228. The method of claim 227, wherein the selectable communication medium is a wireless network.

229. The method of claim 228, wherein the selectable communication medium includes one or more of a Wi-Fi network, a GPRS (General Packet Radio Service) network, a CDMA (Code Division Multiple Access) network, a GSM (Global System for Mobile communications) network, and a satellite network.

230. The method of claim 227, further comprising the step of:
switching to a different selectable communication media, during reception of the data.

231. The method of claim 227, wherein the frame comprises a frame header and a frame body, the frame header including an agent type, an agent name, and a data length, and the frame body including a data buffer corresponding to the data length.

232. The method of claim 231, wherein the agent type is a one byte field indicating a value selectable from: real time, batch, and auto.

233. The method of claim 231, wherein the agent name is a 40 byte field and contains a name of an object, wherein the object includes the data and executable code.

234. The method of claim 231, wherein the data length is a 4 byte field indicating a size in bytes of the data buffer.

235. The method of claim 231, wherein the data buffer is a variable size buffer containing the data to be transmitted.

236. The method of claim 227, wherein each TXU packet comprises a packet header and a packet body, the packet header including a packet type, a session ID, a pipe number, and a packet length, and the packet body including packet data corresponding to the packet length.

237. The method of claim 236, wherein the packet type is a one byte field indicating a value for the packet type.

238. The method of claim 236, wherein the session ID is a 4 byte field identifying a destination.

239. The method of claim 238, wherein the pipe number is a 4 byte field identifying a connection to the destination.

240. The method of claim 236, wherein the packet length is a 2 byte field indicating a size in bytes of the packet data.

241. The method of claim 236, wherein the packet length is a predetermined value corresponding to the selectable communication medium.

242. The method of claim 227, wherein a UDP segment from the plurality of UDP segments comprises, a UDP header and a UDP body, the UDP header including a UDP type, a packet ID, a segment number, a last segment, and the UDP body including a data payload of predetermined size.

243. The method of claim 242, wherein the UDP type indicates a value selectable from: UDP Segment, UDP ACK, UDP NAK, and UDP Probe.

244. The method of claim 242, wherein the packet ID identifies the TXU packet to which the UDP segment is designated.

245. The method of claim 242, wherein the segment number indicates a sequential ordering of the UDP segment within the TXU packet.

246. The method of claim 242, wherein the last segment indicates the segment number corresponding to a final UDP segment in the TXU packet.

247. The method of claim 227, further comprising the step of:
upon sending a NAK to the first computing device, waiting a predetermined probe time without receiving a UDP segment, prior to sending at least one probe message to the first computing device.

248. The method of claim 247, wherein the at least one probe message includes a segment number for the UDP segment most recently received.

249. The method of claim 247, wherein a predetermined probe retry count denotes a count of the at least one probe message to send to the first computing device without receiving the UDP segment, before reporting an error.

Aspect 4 (Agent): Methods and Systems for transporting agents to perform tasks among multiple computing devices.

250. A method for transporting agents having a plurality of related tasks, that enables agents to perform tasks at separate computing devices, comprising steps of:
at a first computing device, having an agent with a first executable code for a first task and a second executable code for a second task:
   determining whether first resources are available at the first computing device;
   upon verifying that first resources are available at the first computing device, performing the first task;
   upon determination that the second task is required, determining whether second resources are available at the first computing device;
   upon determination that the second resources are not available at the first computing device, determining whether the second resources are available at a second computing device; and
   upon determination that the second resources are available at the second computing device, transporting the agent through a selectable communication medium to the second computing device; and
at the second computing device:
   receiving the agent from the first computing device; and
   performing the second task.

251. The method of claim 250, wherein the selectable communication medium is a wireless network.

252. The method of claim 251, wherein the selectable communication medium includes one or more of a Wi-Fi network, a GPRS (General Packet Radio Service) network, a CDMA (Code Division Multiple Access) network, a GSM (Global System for Mobile communications) network, and a satellite network.

253. The method of claim 252, further comprising:
switching to a different selectable communication medium during transmission of agent data.

254. The method of claim 252, further comprising:
switching to a different selectable communication medium during reception of agent data.

255. The method of claim 250, the transporting further comprising:
constructing a frame for agent data, wherein the agent data includes the first executable code for the first task, and the second executable code for the second task;
dividing the frame into a plurality of TXU packets that collectively comprise a frame body;
dividing a TXU packet from the plurality of TXU packets into a plurality of UDP segments;
grouping the plurality of UDP segments into at least one window, for transmission through the selectable communication medium, wherein the at least one window includes a predetermined number of UDP segments from the plurality of UDP segments; and
sending the at least one window to the second computing device.

256. The method of claim 255, further comprising:
upon receiving a NAK message, retransmitting at least one missing UDP segment to the second computing device.

257. The method of claim 255, the receiving further comprising:
receiving UDP segments from among the plurality of UDP segments;
assembling the UDP segments to recreate the TXU packet;
upon determination that a UDP segment from received UDP segments corresponds to a window first segment prior to a final window first segment for the TXU packet, sending an ACK to the first computing device;
upon determination that at least one UDP segment from the UDP segments was not received, sending a NAK message to the first computing device, the NAK message specifying a segment number for each missing UDP segment; and
upon determination that a final UDP segment from the UDP segments for the TXU packet has been received, sending an ACK message to the first computing device;

258. The method of claim 257, further comprising:
upon determination that a final TXU packet for the frame has been assembled, recreating the frame for the agent data by reassembling the plurality of TXU packets,
wherein the recreating occurs prior to the performing.

259. The method of claim 255, wherein the predetermined number of UDP segments for the at least one window is an optimized value corresponding to the selectable communication medium.

260. The method of claim 255, wherein a UDP segment length indicates a UDP segment size for a UDP segment from the plurality of UDP segments, the UDP segment size having a value corresponding to the selectable communication medium.

261. The method of claim 255, wherein a window length equals the predetermined number of UDP segments from the plurality of UDP segments, the window length having a value corresponding to the selectable communication medium.

262. The method of claim 255, wherein the frame comprises a frame header and the frame body, the frame header including an agent type, an agent name, and a data length, and the frame body including a data buffer corresponding to the data length.

263. The method of claim 262, wherein the agent name contains a name of an object that includes the agent data and executable code.

264. The method of claim 262, wherein the data length indicates a size in bytes of the data buffer.

265. The method of claim 262, wherein the data buffer is a variable size buffer containing the agent data to be transmitted.

266. The method of claim 255, wherein the TXU packet comprises a packet header and a packet body, the packet header including a packet type, a session ID, a pipe number, and a packet length, and the packet body including packet data corresponding to the packet length.

267. The method of claim 266, wherein the packet type indicates a value for the packet type.

268. The method of claim 266, wherein the session ID identifies a destination entity.

269. The method of claim 268, wherein the pipe number identifies a connection to the destination entity.

270. The method of claim 266, wherein the packet length indicates a size in bytes of the packet data.

271. The method of claim 266, wherein the packet length is a predetermined value corresponding to the selectable communication medium.

272. The method of claim 255, wherein a UDP segment from the plurality of UDP segments comprises a UDP header and a UDP body, the UDP header including a UDP type, a packet ID, a segment number, a last segment, and the UDP body including a data payload of predetermined size.

273. The method of claim 272, wherein the UDP type indicates a value selectable from: UDP Segment, UDP ACK, UDP NAK, and UDP Probe.

274. The method of claim 272, wherein the packet ID identifies the TXU packet to which the UDP segment is designated.

275. The method of claim 272, wherein the segment number indicates a sequential ordering of the UDP segment within the TXU packet.

276. The method of claim 272, wherein the last segment indicates the segment number corresponding to a final segment in the TXU packet.

277. The method of claim 250, further comprising the step of:
at the first computing device, waiting a predetermined probe time without receiving an ACK or a NAK prior to sending at least one probe message to the second computing device.

278. The method of claim 277, wherein the at least one probe message includes a segment number of a recent UDP segment for which the ACK was received.

279. The method of claim 277, wherein a predetermined probe retry count denotes the number of the at least one probe message to send to the second computing device, without receiving the ACK or the NAK, before reporting an error.

280. The method of claim 250, further comprising the step of:
at the second computing device, upon sending a NAK to the first computing device, waiting a predetermined probe time without receiving a UDP segment prior to sending at least one probe message to the first computing device.

281. The method of claim 280, wherein the at least one probe message includes a segment number for the UDP segment most recently received.

282. The method of claim 280, wherein a predetermined probe retry count denotes the number of the at least one probe message to send to the first computing device, without receiving the UDP segment, before reporting an error.

283. A method for transporting agents having a plurality of related tasks, that enables agents to perform tasks at separate computing devices, comprising steps of:
at a first computing device, having an agent with a first executable code for a first task and a second executable code for a second task, upon determination that the first task is required:
   determining whether first resources are available at the first computing device;
   upon verifying that first resources are available at the first computing device, performing the first task;
   upon determination that the second task is required, determining whether second resources are available at the first computing device;
   upon determination that the second resources are not available at the first computing device, determining whether the second resources are available at a second computing device;
   upon determination that the second resources are available at the second computing device, transporting the agent to the second computing device, the transporting comprising:
      transmitting the agent through a selectable communication medium to the second computing device the transmitting comprising:
         constructing a frame for agent data, wherein the agent data includes the first executable code for the first task, and the second executable code for the second task;
         dividing the frame into a plurality of TXU packets that collectively comprise a frame body;
         dividing a TXU packet from the plurality of TXU packets into a plurality of UDP segments;
         grouping the plurality of UDP segments into at least one window, for transmission through the selectable communication medium, wherein the at least one window includes a predetermined number of UDP segments from the plurality of UDP segments; and
         sending the at least one window to the second computing device;
at the second computing device, receiving the agent data through the selectable communication medium from the first computing device, the receiving comprising:
   receiving UDP segments from among the plurality of UDP segments; assembling the UDP segments to recreate the TXU packet;
   upon determination that a UDP segment from received UDP segments corresponds to a window first segment prior to a final window first segment for the TXU packet, sending an ACK to the first computing device;
   upon determination that at least one UDP segment from the UDP segments was not received, sending a NAK message to the first computing device, the NAK message specifying a segment number for each missing UDP segment; and
   upon determination that a final UDP segment from the UDP segments for the TXU packet has been received, sending an ACK message to the first computing device;
at the first computing device, upon receiving the NAK message,
   retransmitting at least one missing UDP segment to the second computing device; and
at the second computing device, upon determination that a final TXU packet for the frame has been assembled,
   recreating the frame for the agent data by reassembling the plurality of TXU packets; and
   performing the second task.

284. The method of claim 283, wherein the selectable communication medium is a wireless network.

285. The method of claim 284, wherein the selectable communication medium includes one or more of a Wi-Fi network, a GPRS (General Packet Radio Service) network, a CDMA (Code Division Multiple Access) network, a GSM (Global System for Mobile communications) network, and a satellite network.

286. The method of claim 285, further comprising:
switching the selectable communication medium, during transmission of the agent data.

287. The method of claim 285, further comprising:
switching the selectable communication medium, during reception of the agent data.

288. The method of claim 283, wherein the predetermined number of UDP segments for the at least one window is an optimized value corresponding to the selectable communication medium.

289. The method of claim 283, wherein a UDP segment length indicates a UDP segment size for the UDP segment, the UDP segment size having a value corresponding to the selectable communication medium.

290. The method of claim 283, wherein a window length equals the predetermined number of UDP segments, the window length having a value corresponding to the selectable communication medium.

291. The method of claim 283, wherein the frame comprises a frame header and the frame body, the frame header including an agent type, an agent name, and a data length, and the frame body including a data buffer corresponding to the data length.

292. The method of claim 291, wherein the agent type indicates a value selectable from: real time, batch, and auto.

293. The method of claim 291, wherein the agent name contains a name of an object that includes the agent data and executable code.

294. The method of claim 291, wherein the data length indicates a size in bytes of the data buffer.

295. The method of claim 291, wherein the data buffer is a variable size buffer containing the agent data to be transmitted.

296. The method of claim 283, wherein the TXU packet comprises a packet header and a packet body, the packet header including a packet type, a session ID, a pipe number, and a packet length, and the packet body including packet data corresponding to the packet length.

297. The method of claim 296, wherein the packet type indicates a value for the packet type.

298. The method of claim 296, wherein the session ID identifies a destination entity.

299. The method of claim 298, wherein the pipe number identifies a connection to the destination entity.

300. The method of claim 296, wherein the packet length indicates a size in bytes of the packet data.

301. The method of claim 296, wherein the packet length is a predetermined value corresponding to the selectable communication medium.

302. The method of claim 283, wherein each UDP segment comprises a UDP header and a UDP body, the UDP header including a UDP type, a packet ID, the segment number, a last segment, and the UDP body including a data payload of predetermined size.

303. The method of claim 302, wherein the UDP type indicates a value selectable from: UDP Segment, UDP ACK, UDP NAK, and UDP Probe.

304. The method of claim 302, wherein the packet ID identifies the TXU packet to which the UDP segment is designated.

305. The method of claim 302, wherein the segment number indicates a sequential ordering of the UDP segment within the TXU packet.

306. The method of claim 302, wherein the last segment indicates the segment number corresponding to a final segment in the TXU packet.

307. The method of claim 283, further comprising the step of:
at the first computing device, waiting a predetermined probe time without receiving the ACK or a NAK prior to sending at least one probe message to the second computing device.

308. The method of claim 307, wherein the at least one probe message includes the segment number of a recent UDP segment for which the ACK was received.

309. The method of claim 307, wherein a predetermined probe retry count denotes a count of the at least one probe message to send to the second computing device, without receiving the ACK or the NAK, before reporting an error.

310. The method of claim 283, further comprising the step of:
at the second computing device, upon sending a NAK to the first computing device, waiting a predetermined probe time without receiving the UDP segment prior to sending at least one probe message to the first computing device.

311. The method of claim 310, wherein the at least one probe message includes the segment number for the UDP segment most recently received.

312. The method of claim 310, wherein a predetermined probe retry count denotes a count of the at least one probe message to send to the first computing device, without receiving the UDP segment, before reporting an error.

Aspect 5 (Virtual Space): Methods and Systems for transporting and executing agents to perform portions of tasks among multiple computing devices.

313. A method for transporting and executing agents having a plurality of related tasks, that enables the agents to execute portions of related tasks at different computing devices, comprising steps of:
at a first computing device:
   receiving an agent into a first module space corresponding to the agent, wherein the first module space comprises space information for transport and execution of the agent;
   upon determination that a first task is required, determining whether first resources are available;
   upon verifying availability of first resources, performing the first task;
   upon determination that a second task is required, determining whether second task resources are available at the first computing device;
   upon determination that the second task resources are unavailable at the first computing device, transporting the agent to a second computing device, the transporting comprising:
      at the first computing device, transmitting the agent through a selectable communication medium to the second computing device the transmitting comprising:
         constructing a frame for agent data;
         dividing the frame into a plurality of TXU packets that collectively comprise a frame body;
         dividing each TXU packet into a plurality of UDP segments;
         grouping the plurality of UDP segments into at least one window for transmitting through the selectable communication medium, wherein the at least one window includes a predetermined number of UDP segments from the plurality of UDP segments; and
         sending the at least one window to the second computing device;
   at the second computing device, receiving the agent data through the selectable communication medium from the first computing device, the receiving comprising:
      receiving at least one UDP segment;
      assembling UDP segments to recreate a TXU packet;
      upon determination that at least one UDP segment was not received, sending a NAK message to the first computing device, the NAK message specifying as missing the at least one UDP segment; and
      upon determination that a final UDP segment for the TXU packet has been received, sending an ACK message to the first computing device;
   at the first computing device, upon receiving the NAK message, retransmitting the at least one UDP segment to the second computing device; and
   at the second computing device, upon determination that a final TXU packet for the frame has been assembled, recreating the frame for the agent data by reassembling the plurality of TXU packets;
performing the second task.

314. The method of claim 313, wherein the selectable communication medium is a wireless network.

315. The method of claim 314, wherein the selectable communication medium includes one or more of a Wi-Fi network, a GPRS (General Packet Radio Service) network, a CDMA (Code Division Multiple Access) network, a GSM (Global System for Mobile communications) network, and a satellite network.

316. The method of claim 315, further comprising:
switching to a different selectable communication media during transmission of the agent.

317. The method of claim 315, further comprising:
switching to a different selectable communication media during reception of the agent.

318. The method of claim 313, wherein the space information comprises a version ID, a session ID, a user ID, a device ID, an encryption key, an IP address, an IP port number, a status, an agent list, a frame list, an error code, and an error message.

319. The method of claim 318, wherein the user ID is provided by an application at the first computing device.

320. The method of claim 318, wherein the device ID is provided by an application at the first computing device.

321. The method of claim 318, wherein the session ID is generated from the user ID and the session ID.

322. The method of claim 318, wherein the encryption key is generated and exchanged using Diffie-Hellman key exchange.

323. The method of claim 318, wherein the IP address contains a network address corresponding to the first computing device.

324. The method of claim 318, wherein the status includes status information about the first module space.

325. The method of claim 318, wherein the agent list identifies the agents.

326. The method of claim 318, wherein the frame list includes a list of frames to be sent or received.

327. The method of claim 318, wherein the error code is the error code occurring most recently during transport of the agent.

328. The method of claim 318, wherein the error message is the error message occurring most recently during transport of the agent.

Aspect 6 (Virtual Session): Methods and Systems for transporting and executing agents to perform tasks at separate computing devices.

329. A method for transporting and executing agents having a plurality of related tasks, that enables agents to perform tasks at separate computing devices, comprising steps of:
at a first computing device, receiving an agent into a first module space corresponding to the agent, wherein the first module space comprises space information for transport and execution of the agent;
upon determination that a task is required, determining whether task resources are available at the first computing device;
upon determination that the task resources are unavailable at the first computing device, transporting the agent to a second computing device, the transporting comprising:
   allocating a session between the first module space on the first computing device and a second module space on the second computing device;
   opening a pipe through the session, the pipe having full duplex capability; and
   transmitting the agent through the pipe to the second module space, wherein the agent is transmitted by the first module space through a selectable communication medium to the second module space;
at the second computing device:
   receiving the agent into the second module space; and
   executing the task.

330. The method of claim 329, wherein the selectable communication medium is a wireless network.

331. The method of claim 330, wherein the selectable communication medium includes one or more of a Wi-Fi network, a GPRS (General Packet Radio Service) network, a CDMA (Code Division Multiple Access) network, a GSM (Global System for Mobile communications) network, and a satellite network.

332. The method of claim 331, further comprising:
switching to a different selectable communication medium during transmission of the agent.

333. The method of claim 331, further comprising:
switching to a different selectable communication medium during reception of the agent.

334. A method for transporting and executing agents having a plurality of related tasks, that enables agents to perform tasks at separate computing devices, comprising steps of:
at a first computing device:
   receiving an agent into a first module space corresponding to the agent, wherein the first module space comprises space information for transport and execution of the agent;
   upon determination that a task is required, determining whether task resources are available at the first computing device;
   upon determination that the task resources are unavailable, transporting the agent to a second computing device, the transporting comprising:
      allocating a session between the first module space and a second module space on the second computing device;
      opening a pipe through the session, the pipe having full duplex capability; and
      transmitting the agent through the pipe to the second module space, the transmitting comprising:
         at the first module space, transmitting the agent through a selectable communication medium to the second module space, the transmitting comprising:
         constructing a frame for the agent;
         dividing the frame into a plurality of TXU packets that collectively comprise a frame body;
         dividing each TXU packet into a plurality of UDP segments;
         grouping the plurality of UDP segments into at least one window for transmitting through the selectable communication medium, wherein the at least one window includes a predetermined number of UDP segments from the plurality of UDP segments; and
         sending the at least one window to the second module space;
at the second computing device:
   receiving the agent into the second module space, the receiving comprising:
      receiving UDP segments from the plurality of UDP segments;
      assembling the UDP segments to recreate a TXU packet;
      upon determination that at least one UDP segment from the plurality of UDP segments was not received, sending a NAK message to the first module space, the NAK message specifying a segment number for each missing UDP segment; and
      upon determination that a final UDP segment for the TXU packet has been received, sending an ACK message to the first computing device;
at the first module space, upon receiving a NAK message, retransmitting missing UDP segments to the second module space; and
at the second module space, upon determination that a final TXU packet for the frame has been assembled:
   recreating the frame for the agent by reassembling the plurality of TXU packets; and
   executing the task.

In view of the foregoing detailed description of preferred embodiments of the present invention, it readily will be understood by those persons skilled in the art that the present invention is susceptible to broad utility and application. While various aspects have been described in the context of a preferred embodiment, additional aspects, features, and methodologies of the present invention will be readily discernable therefrom. Many embodiments and adaptations of the present invention other than those herein described, as well as many variations, modifications, and equivalent arrangements and methodologies, will be apparent from or reasonably suggested by the present invention and the foregoing description thereof, without departing from the substance or scope of the present invention. Furthermore, any sequence(s) and/or temporal order of steps of various processes described and claimed herein are those considered to be the best mode contemplated for carrying out the present invention. It should also be understood that, although steps of various processes may be shown and described as being in a preferred sequence or temporal order, the steps of any such processes are not limited to being carried out in any particular sequence or order, absent a specific indication of such to achieve a particular intended result. In most cases, the steps of such processes may be carried out in a variety of different sequences and orders, while still falling within the scope of the present inventions. In addition, some steps may be carried out simultaneously. Accordingly, while the present invention has been described herein in detail in relation to preferred embodiments, it is to be understood that this disclosure is only illustrative and exemplary of the present invention and is made merely for purposes of providing a full and enabling disclosure of the invention. The foregoing disclosure is not intended nor is to be construed to limit the present invention or otherwise to exclude any such other embodiments, adaptations, variations, modifications and equivalent arrangements, the present invention being limited only by the claims appended hereto and to the equivalents thereof.

What is claimed is:

1. A method for data communication between a remote electronic device and a server, comprising steps of:
at the remote electronic device:
transmitting data through a selectable communication medium to the server, further comprising:
constructing a frame for data, the frame comprising a frame header and a frame body, the frame header including an agent type, an agent name, and a data length, and the frame body including a data buffer corresponding to the data length;
dividing the frame into a plurality of TXU packets that collectively comprise the frame body, wherein a TXU packet from the plurality of TXU packets comprises a packet header and a packet body, the packet header including a packet type, a session ID, a pipe number, and a packet length, and the packet body including packet data corresponding to the packet length;
dividing the TXU packet into a plurality of UDP segments, wherein a UDP segment from the plurality of UDP segments comprises a UDP header and a UDP body, the UDP header including a UDP type, a packet ID, a segment number, a last segment, and the UDP body including a data payload of predetermined size;
grouping the plurality of UDP segments into at least one window, for transmission through the selectable communication medium, wherein the at least one window includes a predetermined number of UDP segments from the plurality of UDP segments; and
sending the at least one window to the server;
at the server, receiving the data through the selectable communication medium from the remote electronic device, the receiving comprising:
receiving at least one UDP segment;
assembling UDP segments to recreate the TXU packet;
upon determination that the segment number of the UDP segment indicates a window first segment prior to a final window first segment for the TXU packet, sending an ACK to the remote electronic device;
upon determination that at least one UDP segment was not received, sending a NAK message to the remote electronic device, the NAK message specifying the segment number for each missing segment; and
upon determination that a final UDP segment for the TXU packet has been received, sending an ACK message to the remote electronic device;
at the remote electronic device, upon receiving the ACK message from the server, if a next window from the at least one window remains to be sent, sending the next window from the remote electronic device to the server;
at the remote electronic device, upon receipt of the NAK message:
retransmitting missing UDP segments to the server, the retransmitting comprising:
identifying a plurality of missing UDP segments according to the NAK message;
grouping the plurality of missing UDP segments into a retransmit window, the retransmit window having a number of UDP segments corresponding to a count of missing UDP segments; and
sending the retransmit window to the server; and
at the server, upon determination that a final TXU packet for the frame has been received, recreating the frame by reassembling the plurality of TXU packets.

2. A method for data communication between a first computing device and a second computing device, comprising steps of:
at the first computing device,
transmitting data through a selectable communication medium to the second computing device the transmitting comprising:
constructing a frame for the data;
dividing the frame into a plurality of TXU packets;
dividing each TXU packet into a plurality of UDP segments;
grouping the plurality of UDP segments into at least one window, wherein the at least one window includes a predetermined number of UDP segments from the plurality of UDP segments; and
sending the at least one window to the second computing device;
at the second computing device, receiving the data through the selectable communication medium from the first computing device, the receiving comprising:
receiving a UDP segment from the plurality of UDP segments;
assembling the plurality of UDP segments to recreate a TXU packet;
upon determination that a last UDP segment, from the plurality of UDP segments, for the TXU packet that has been received, sending an ACK message to the first computing device; and
upon determination that at least one UDP segment, from the plurality of UDP segments, was not received, sending a NAK message, that specifies each missing segment, to the first computing device;
at the first computing device, upon receiving the ACK message, if a next window from the at least one window remains to be sent, sending the next window from the first computing device to the second computing device;
at the first computing device, upon receiving a NAK message, retransmitting at least one missing UDP segment, from the plurality of UDP segments to the second computing device; and
at the second computing device, upon determination that a final TXU packet for the frame has been received, recreating the frame by reassembling the plurality of TXU packets.

3. A method for data communication between a remote electronic device and a server, comprising steps of:
transmitting data from the remote electronic device through a selectable communication medium to the server, the transmitting comprising:
constructing a frame for data, the frame comprising a frame header and a frame body, the frame header including an agent type, an agent name, and a data length, and the frame body including a data buffer corresponding to the data length;
dividing the frame into a plurality of TXU packets that collectively comprise the frame body, wherein a TXU packet from the plurality of TXU packets comprises a packet header and a packet body, the packet header including a packet type, a session ID, a pipe number, and a packet length, and the packet body including packet data corresponding to the packet length;
dividing the TXU packet into a plurality of UDP segments, wherein a UDP segment from the plurality of UDP segments comprises a UDP header and a UDP body, the UDP header including a UDP type, a packet ID, a segment number, a last segment, and the UDP body including a data payload of predetermined size;
grouping the plurality of UDP segments into at least one window, for transmission through the selectable communication medium, wherein the at least one window includes a predetermined number of UDP segments from the plurality of UDP segments; and
sending the at least one window to the server;
upon receiving an ACK message from the server, if a next window from the at least one window remains to be sent, sending the next window from the remote electronic device to the server;
upon receipt of a NAK message:
retransmitting missing UDP segments from the remote electronic device to the server, the retransmitting comprising:
identifying a plurality of missing UDP segments according to the NAK message;
grouping the plurality of missing UDP segments into a retransmit window, the retransmit window having a number of UDP segments corresponding to a count of missing UDP segments; and
sending the retransmit window to the server.

4. The method of claim 3, wherein the selectable communication medium is a wireless network.

5. The method of claim 4, wherein the selectable communication medium includes one or more of a Wi-Fi network, a GPRS (General Packet Radio Service) network, a CDMA (Code Division Multiple Access) network, a GSM (Global System for Mobile communications) network, and a satellite network.

6. The method of claim 5, further comprising the step of:
switching to a different selectable communication media during transmission of the data.

7. The method of claim 3, wherein the predetermined number of UDP segments for the at least one window is an optimized value corresponding to the selectable communication medium.

8. The method of claim 3, wherein the packet length is a predetermined value corresponding to the selectable communication medium.

9. The method of claim 3, wherein a UDP segment length indicates the size of the UDP segment, the UDP segment length having a value corresponding to the selectable communication medium.

10. The method of claim 3, wherein a window length equals the predetermined number of UDP segments, the window length having a value corresponding to the selectable communication medium.

11. The method of claim 3, further comprising the step of:
at the remote electronic device waiting a predetermined probe time without receiving an ACK or a NAK before sending a probe message to the server.

12. The method of claim 11, wherein the probe message includes the segment number of a recent UDP segment for which the ACK was received.

13. The method of claim 11, wherein a predetermined probe retry count denotes a number of probe messages to send to the server without receiving the ACK or the NAK before reporting an error.

14. A method for receiving data from a remote electronic device through a selectable communication medium, comprising steps of:
receiving a plurality of UDP segments, wherein a UDP segment from the plurality of UDP segments comprises a UDP header and a UDP body, the UDP header including a UDP type, a packet ID, a segment number, a last segment, and the UDP body including a data payload of predetermined size;
upon determination that the segment number indicates a first UDP segment, creating a TXU packet, the TXU packet comprising a packet header, and a packet body, the packet header including a packet type, a session ID, a pipe number, and a packet length, and the packet body including packet data corresponding to the packet length;
upon determination that the segment number indicates the UDP segment sequentially after the first UDP segment, adding the UDP segment to the TXU packet;
upon determination that the segment number indicates an initial segment in a window prior to a final window initial segment for the TXU packet, sending an ACK to the remote electronic device;
upon determination that the UDP segment was not received, sending a NAK message to the remote electronic device, the NAK message specifying the segment number for each missing segment;
upon determination that the segment number indicates the last segment, verifying that all UDP segments have been received;
upon determination that all UDP segments have been received, sending an ACK message to the remote electronic device;
upon determination that a final TXU packet has been received, recreating a frame by reassembling a plurality of TXU packets, the frame comprising a frame header and a frame body, the frame header including an agent type, an agent name, and a data length, and the frame body including a data buffer for data and corresponding to the data length.

15. The method of claim 14, wherein the selectable communication medium is a wireless network.

16. The method of claim 15, wherein the selectable communication medium includes one or more of a Wi-Fi network, a GPRS (General Packet Radio Service) network, a CDMA (Code Division Multiple Access) network, a GSM (Global System for Mobile communications) network, and a satellite network.

17. The method of claim 16, further comprising the step of:
switching to a different selectable communication media during reception of the data.

18. The method of claim 14, further comprising the step of:
upon sending a NAK to the remote electronic device, waiting a predetermined probe time without receiving the UDP segment before sending a probe message to the remote electronic device.

19. The method of claim 18, wherein the probe message includes the segment number for the UDP segment most recently received.

20. The method of claim 18, wherein a predetermined probe retry count denotes a count of probe messages to send to the remote electronic device, without receiving the UDP segment before reporting an error.

21. A system for data communication between multiple computing devices, the system comprising:
a first computing device configured for communication through a selectable communication medium with a second computing device, the first computing device comprising:
a first TXM module operable for:
receiving the data from a first application;
constructing a frame for the data;
dividing the frame into a plurality of TXU packets that collectively comprise a frame body;
sending a TXU packet from the plurality of TXU packets to a first TXU module; and
upon receiving notification that the TXU packet has been sent successfully, if a next TXU packet from the plurality of TXU packets remains to be sent, sending the next TXU packet to the first TXU module;
the first TXU module operable for:
receiving the TXU packet from the first TXM module;
dividing the TXU packet into a plurality of UDP segments;
grouping the plurality of UDP segments into at least one window, wherein the at least one window includes a predetermined number of UDP segments from the plurality of UDP segments; and
sending the at least one window through the selectable communication medium to a second TXU module at the second computing device;
upon receipt of an ACK message, if a next window remains, sending the next window to the second TXU module; and
upon the receipt of a NAK message, wherein the NAK message specifies at least one missing UDP segment, retransmitting the at least one missing UDP segment to the second TXU module;
the second computing device configured for communication through the selectable communication medium with the first computing device, the second computing device comprising:
the second TXU module operable for:
receiving a UDP segment of the at least one window, through the selectable communication medium from the first TXU module;
assembling the UDP segment to recreate the TXU packet;
upon determination that at least one different UDP segment was not received, sending the NAK message through the selectable communication medium to the first TXU module, the NAK message specifying the at least one missing UDP segment that corresponds to the at least one different UDP segment; and
upon determination that a final UDP segment for the TXU packet has been received:
sending the ACK message to the first TXU module;
sending the TXU packet to a second TXM module;
the second TXM module operable for:
receiving the TXU packet from the second TXU module;
upon determination that the TXU packet is a first TXU packet for a new frame, creating the new frame;
upon determination that a final TXU packet for the new frame has been received, recreating the new frame by reassembling the plurality of TXU packets that include the data; and
providing the data from the new frame to a second application.

22. The system of claim 21, wherein the first TXU module is further configured for waiting a predetermined probe time, without receiving an ACK or a NAK, before sending a probe message to the second TXU module.

23. The system of claim 22, wherein a predetermined probe retry count denotes a count of probe messages to send to the second TXU module, without receiving the ACK or the NAK, before reporting an error.

24. The system of claim 21, wherein the first computing device is further configured for:
upon sending a NAK to the second computing device, waiting a predetermined probe time, without receiving the UDP segment, before sending a probe message to the second computing device.

25. The system of claim 24, wherein a predetermined probe retry count denotes a count of probe messages to send to the first TXU module, without receiving the UDP segment, before reporting an error.

26. A method for transporting agents having a plurality of related tasks, that enables agents to perform tasks at separate computing devices, comprising steps of:
at a first computing device, having an agent with a first executable code for a first task and a second executable code for a second task:
determining whether first resources are available at the first computing device;
upon verifying that first resources are available at the first computing device, performing the first task;
upon determination that the second task is required, determining whether second resources are available at the first computing device;
upon determination that the second resources are not available at the first computing device, determining whether the second resources are available at a second computing device; and
upon determination that the second resources are available at the second computing device, transporting the agent through a selectable communication medium to the second computing device; and
at the second computing device:
receiving the agent from the first computing device; and
performing the second task.

27. The method of claim 26, wherein the selectable communication medium is a wireless network.

28. The method of claim 27, wherein the selectable communication medium includes one or more of a Wi-Fi network, a GPRS (General Packet Radio Service) network, a CDMA (Code Division Multiple Access) network, a GSM (Global System for Mobile communications) network, and a satellite network.

29. The method of claim 28, further comprising:
switching to a different selectable communication medium during transmission of agent data.

30. The method of claim 28, further comprising:
switching to a different selectable communication medium during reception of agent data.

31. The method of claim 26, the transporting further comprising:
constructing a frame for agent data, wherein the agent data includes the first executable code for the first task, and the second executable code for the second task;
dividing the frame into a plurality of TXU packets that collectively comprise a frame body;
dividing a TXU packet from the plurality of TXU packets into a plurality of UDP segments;
grouping the plurality of UDP segments into at least one window, for transmission through the selectable communication medium, wherein the at least one window includes a predetermined number of UDP segments from the plurality of UDP segments; and
sending the at least one window to the second computing device.

32. The method of claim 31, further comprising:
upon receiving a NAK message, retransmitting at least one missing UDP segment to the second computing device.

33. The method of claim 31, the receiving further comprising:
receiving UDP segments from among the plurality of UDP segments;
assembling the UDP segments to recreate the TXU packet;
upon determination that a UDP segment from received UDP segments corresponds to a window first segment prior to a final window first segment for the TXU packet, sending an ACK to the first computing device;
upon determination that at least one UDP segment from the UDP segments was not received, sending a NAK message to the first computing device, the NAK message specifying a segment number for each missing UDP segment; and
upon determination that a final UDP segment from the UDP segments for the TXU packet has been received, sending an ACK message to the first computing device;

34. The method of claim 33, further comprising:
upon determination that a final TXU packet for the frame has been assembled, recreating the frame for the agent data by reassembling the plurality of TXU packets,
wherein the recreating occurs prior to the performing.

35. The method of claim 31, wherein the predetermined number of UDP segments for the at least one window is an optimized value corresponding to the selectable communication medium.

36. The method of claim 31, wherein a UDP segment length indicates a UDP segment size for a UDP segment from the plurality of UDP segments, the UDP segment size having a value corresponding to the selectable communication medium.

37. The method of claim 31, wherein a window length equals the predetermined number of UDP segments from the plurality of UDP segments, the window length having a value corresponding to the selectable communication medium.

38. The method of claim 26, further comprising the step of:
at the first computing device, waiting a predetermined probe time without receiving an ACK or a NAK prior to sending at least one probe message to the second computing device.

39. The method of claim 38, wherein the at least one probe message includes a segment number of a recent UDP segment for which the ACK was received.

40. The method of claim 38, wherein a predetermined probe retry count denotes the number of the at least one probe message to send to the second computing device, without receiving the ACK or the NAK, before reporting an error.

41. The method of claim 26, further comprising the step of:
at the second computing device, upon sending a NAK to the first computing device, waiting a predetermined probe time without receiving a UDP segment prior to sending at least one probe message to the first computing device.

42. The method of claim 41, wherein the at least one probe message includes a segment number for the UDP segment most recently received.

43. The method of claim 41, wherein a predetermined probe retry count denotes the number of the at least one probe message to send to the first computing device, without receiving the UDP segment, before reporting an error.

44. A method for transporting agents having a plurality of related tasks, that enables agents to perform tasks at separate computing devices, comprising steps of:
at a first computing device, having an agent with a first executable code for a first task and a second executable code for a second task, upon determination that the first task is required:
determining whether first resources are available at the first computing device;
upon verifying that first resources are available at the first computing device, performing the first task;
upon determination that the second task is required, determining whether second resources are available at the first computing device;
upon determination that the second resources are not available at the first computing device, determining whether the second resources are available at a second computing device;
upon determination that the second resources are available at the second computing device, transporting the agent to the second computing device, the transporting comprising:
transmitting the agent through a selectable communication medium to the second computing device the transmitting comprising:
constructing a frame for agent data, wherein the agent data includes the first executable code for the first task, and the second executable code for the second task;
dividing the frame into a plurality of TXU packets that collectively comprise a frame body;
dividing a TXU packet from the plurality of TXU packets into a plurality of UDP segments;
grouping the plurality of UDP segments into at least one window, for transmission through the selectable communication medium, wherein the at least one window includes a predetermined number of UDP segments from the plurality of UDP segments; and
sending the at least one window to the second computing device;
at the second computing device, receiving the agent data through the selectable communication medium from the first computing device, the receiving comprising:
receiving UDP segments from among the plurality of UDP segments;
assembling the UDP segments to recreate the TXU packet;
upon determination that a UDP segment from received UDP segments corresponds to a window first segment prior to a final window first segment for the TXU packet, sending an ACK to the first computing device;
upon determination that at least one UDP segment from the UDP segments was not received, sending a NAK message to the first computing device, the NAK message specifying a segment number for each missing UDP segment; and
upon determination that a final UDP segment from the UDP segments for the TXU packet has been received, sending an ACK message to the first computing device;
at the first computing device, upon receiving the NAK message, retransmitting at least one missing UDP segment to the second computing device; and
at the second computing device, upon determination that a final TXU packet for the frame has been assembled,
recreating the frame for the agent data by reassembling the plurality of TXU packets; and
performing the second task.

45. The method of claim 44, further comprising the step of:
at the first computing device, waiting a predetermined probe time without receiving the ACK or a NAK prior to sending at least one probe message to the second computing device.

46. The method of claim 45, wherein the at least one probe message includes the segment number of a recent UDP segment for which the ACK was received.

47. The method of claim 45, wherein a predetermined probe retry count denotes a count of the at least one probe message to send to the second computing device, without receiving the ACK or the NAK, before reporting an error.

48. The method of claim 44, further comprising the step of:
at the second computing device, upon sending a NAK to the first computing device, waiting a predetermined probe time without receiving the UDP segment prior to sending at least one probe message to the first computing device.

49. The method of claim 48, wherein the at least one probe message includes the segment number for the UDP segment most recently received.

50. The method of claim 48, wherein a predetermined probe retry count denotes a count of the at least one probe message to send to the first computing device, without receiving the UDP segment, before reporting an error.

51. A method for transporting and executing agents having a plurality of related tasks, that enables the agents to execute portions of related tasks at different computing devices, comprising steps of:
at a first computing device:
receiving an agent into a first module space corresponding to the agent, wherein the first module space comprises space information for transport and execution of the agent;
upon determination that a first task is required, determining whether first resources are available;
upon verifying availability of first resources, performing the first task;
upon determination that a second task is required, determining whether second task resources are available at the first computing device;
upon determination that the second task resources are unavailable at the first computing device, transporting the agent to a second computing device, the transporting comprising:
at the first computing device, transmitting the agent through a selectable communication medium to the second computing device the transmitting comprising:
constructing a frame for agent data;
dividing the frame into a plurality of TXU packets that collectively comprise a frame body;
dividing each TXU packet into a plurality of UDP segments;
grouping the plurality of UDP segments into at least one window for transmitting through the selectable communication medium, wherein the at least one window includes a predetermined number of UDP segments from the plurality of UDP segments; and
sending the at least one window to the second computing device;
at the second computing device, receiving the agent data through the selectable communication medium from the first computing device, the receiving comprising:
receiving at least one UDP segment;
assembling UDP segments to recreate a TXU packet;
upon determination that at least one UDP segment was not received, sending a NAK message to the first computing device, the NAK message specifying as missing the at least one UDP segment; and
upon determination that a final UDP segment for the TXU packet has been received, sending an ACK message to the first computing device;
at the first computing device, upon receiving the NAK message, retransmitting the at least one UDP segment to the second computing device; and
at the second computing device, upon determination that a final TXU packet for the frame has been assembled, recreating the frame for the agent data by reassembling the plurality of TXU packets;
performing the second task.

52. The method of claim 51, wherein the selectable communication medium is a wireless network.

53. The method of claim 52, wherein the selectable communication medium includes one or more of a Wi-Fi network, a GPRS (General Packet Radio Service) network, a CDMA (Code Division Multiple Access) network, a GSM (Global System for Mobile communications) network, and a satellite network.

54. The method of claim 53, further comprising:
switching to a different selectable communication media during transmission of the agent.

55. The method of claim 53, further comprising:
switching to a different selectable communication media during reception of the agent.

56. The method of claim 51, wherein the space information comprises a version ID, a session ID, a user ID, a device ID, an encryption key, an IP address, an IP port number, a status, an agent list, a frame list, an error code, and an error message.

57. The method of claim 56, wherein the user ID is provided by an application at the first computing device.

58. The method of claim 56, wherein the device ID is provided by an application at the first computing device.

59. The method of claim 56, wherein the session ID is generated from the user ID and the session ID.

60. The method of claim 56, wherein the encryption key is generated and exchanged using Diffie-Hellman key exchange.

61. The method of claim 56, wherein the IP address contains a network address corresponding to the first computing device.

62. The method of claim 56, wherein the status includes status information about the first module space.

63. The method of claim 56, wherein the agent list identifies the agents.

64. The method of claim 56, wherein the frame list includes a list of frames to be sent or received.

65. The method of claim 56, wherein the error code is the error code occurring most recently during transport of the agent.

66. The method of claim 56, wherein the error message is the error message occurring most recently during transport of the agent.

67. A method for transporting and executing agents having a plurality of related tasks, that enables agents to perform tasks at separate computing devices, comprising steps of:
at a first computing device, receiving an agent into a first module space corresponding to the agent, wherein the first module space comprises space information for transport and execution of the agent;
upon determination that a task is required, determining whether task resources are available at the first computing device;
upon determination that the task resources are unavailable at the first computing device, transporting the agent to a second computing device, the transporting comprising:
allocating a session between the first module space on the first computing device and a second module space on the second computing device;
opening a pipe through the session, the pipe having full duplex capability; and
transmitting the agent through the pipe to the second module space, wherein the agent is transmitted by the first module space through a selectable communication medium to the second module space;
at the second computing device:
receiving the agent into the second module space; and
executing the task.

68. The method of claim 67, wherein the selectable communication medium is a wireless network.

69. The method of claim 68, wherein the selectable communication medium includes one or more of a Wi-Fi network, a GPRS (General Packet Radio Service) network, a CDMA (Code Division Multiple Access) network, a GSM (Global System for Mobile communications) network, and a satellite network.

70. The method of claim 69, further comprising:
switching to a different selectable communication medium during transmission of the agent.

71. The method of claim 69, further comprising:
switching to a different selectable communication medium during reception of the agent.

72. A method for transporting and executing agents having a plurality of related tasks, that enables agents to perform tasks at separate computing devices, comprising steps of:
at a first computing device:
receiving an agent into a first module space corresponding to the agent, wherein the first module space comprises space information for transport and execution of the agent;
upon determination that a task is required, determining whether task resources are available at the first computing device;
upon determination that the task resources are unavailable, transporting the agent to a second computing device, the transporting comprising:
allocating a session between the first module space and a second module space on the second computing device;
opening a pipe through the session, the pipe having full duplex capability; and
transmitting the agent through the pipe to the second module space, the transmitting comprising:
at the first module space, transmitting the agent through a selectable communication medium to the second module space, the transmitting comprising:
constructing a frame for the agent;
dividing the frame into a plurality of TXU packets that collectively comprise a frame body;
dividing each TXU packet into a plurality of UDP segments;
grouping the plurality of UDP segments into at least one window for transmitting through the selectable communication medium, wherein the at least one window includes a predetermined number of UDP segments from the plurality of UDP segments; and
sending the at least one window to the second module space;
at the second computing device:
receiving the agent into the second module space, the receiving comprising:
receiving UDP segments from the plurality of UDP segments;
assembling the UDP segments to recreate a TXU packet;
upon determination that at least one UDP segment from the plurality of UDP segments was not received, sending a NAK message to the first module space, the NAK message specifying a segment number for each missing UDP segment; and
upon determination that a final UDP segment for the TXU packet has been received, sending an ACK message to the first computing device;
at the first module space, upon receiving a NAK message, retransmitting missing UDP segments to the second module space; and
at the second module space, upon determination that a final TXU packet for the frame has been assembled:
recreating the frame for the agent by reassembling the plurality of TXU packets; and
executing the task.
